(19) United States
(12) Patent Application Publication
(10) Pub. No.: US 2013/0187780 A1
(43) Pub. Date: Jul. 25, 2013

(54) Method and Device for Personalized Interactive Monitoring for Diabetes

(71) Applicant: EOSHEALTH, INC., Houston, TX (US)

(72) Inventor: Kimon J. Angelides, Houston, TX (US)

(73) Assignee: EOSHEALTH, INC., Houston, TX (US)

(21) Appl. No.: 13/793,208

(22) Filed: Mar. 11, 2013

Related U.S. Application Data
(63) Continuation-in-part of application No. 13/705,341, filed on Dec. 5, 2012.
Application No. 13/705,341 is a continuation-in-part of application No. 13/656,692, filed on Oct. 20, 2012.
Application No. 13/656,692 is a continuation-in-part of application No. 13/485,849, filed on May 31, 2012.
Application No. 13/485,849 is a continuation-in-part of application No. 12/693,849, filed on Jan. 26, 2010.
(60) Provisional application No. 61/147,157, filed on Jan. 26, 2009.

(51) Int. Cl. G08B 21/02

(52) U.S. Cl. CPC G08B 21/02
USPC 340/573.1

(57) ABSTRACT

The invention relates to a method of doing business based on a device which interacts with a server and with the user's health monitors (including physicians), and through these interactions guides the user to eat, exercise and test blood glucose and ketones so as to help maintain blood glucose (BG) and ketone levels at desirable levels, and also logs the results. The device is a wireless-linked (to the server) combination glucometer/accelerometer, which displays a series of user-interactive screens, having only a few icons per screen, which the user can selectively activate.

### RELATED APPLICATIONS

This application is a CIP of and claims priority to U.S. application Ser. No. 13/705,341, filed Dec. 5, 2012 (pending), which is a CIP of and claims priority to U.S. application Ser. No. 13/656,692, filed Oct. 20, 2012 (pending), which is a CIP of claims priority to U.S. application Ser. No. 13/485,849, filed May 31, 2012 (pending), which is a CIP of claims priority to U.S. application Ser. No. 12/693,849, filed Jan. 26, 2010 (pending), which is a nonprovisional of and claims priority to U.S. Provisional No. 61/147,157, filed Jan. 26, 2009. All these applications are incorporated by reference, and the device and method described and claimed herein can include all features of any of the devices and methods disclosed in any of these applications.

### BACKGROUND

As America's fifth-deadliest disease, and as there are over 20 million American diabetics, diabetes mellitus places a particularly high expense burden on the public healthcare system. Millions of Americans are not even aware that they have the disease, and an additional 50 million plus Americans have pre-diabetes. If the present trends continues, 1 in 3 Americans, including as many as 1 in 2 minorities born in 2000 will develop diabetes during their lifetime.

Diabetes is a group of chronic metabolic diseases marked by high levels of blood glucose resulting from defects in insulin production, insulin action, or both. While diabetes can lead to serious complications and premature death, effective treatment requires the diabetic patient to take steps to control the disease and lower the risk of complications.

About 5-10% of diabetics have Type 1 diabetes, while 90-95% have Type 2 diabetes. Type 1 is an autoimmune disease while Type 2 results from insulin resistance or inadequate insulin production. Type 1 has clear genetic markers while Type 2 is genetically heterogenous and therefore has a broader and less certain origin. About 80% of Type 2 diabetics are overweight.

Since 1987, the death rate due to diabetes has increased by 45 percent, while the death rates due to heart disease, stroke, and cancer have declined, emphasizing both the failures of the current treatment approaches as well as the rapid growth of this disease.

Uncontrolled diabetes leads to chronic end-stage organ disease and in the United States is a leading cause of end-stage renal disease, blindness, non-traumatic amputation, and cardiovascular disease. It is also associated with complications such as:
Heart Disease and Stroke (#1 cause of death for diabetics and 2-4 time higher than the general population)
High Blood Pressure (3 in 4 diabetics)
Nervous System Damage (can lead to amputations and carpel tunnel syndrome)
Pregnancy Complications (including gestational diabetes)
Sexual Dysfunction (double the incidence of erectile dysfunction)
Periodontal Disease

In the USA, over 85% of people aged 65 and over have diabetes, a fact that complicates their total health picture and often accelerates chronic end-stage disease, adding an enormous strain to the healthcare system. Prevalence is highest among minorities and increases in all groups with age and obesity. In addition, there are correlations of higher diabetes incidence with smokers, and Alzheimer's patients.

Poor control of blood-glucose in diabetes dramatically increases the risk of heart disease, stroke, amputations, blindness, renal disease and failure, impotence, and many other diseases—better control of blood-glucose levels greatly mitigates these complications. Coupled with proper education, nutrition, maintenance of stable blood-glucose levels, and regular exercise, many Type 1 and 2 diabetics can minimize the effects of the disease.

With the growing problem of diabetes in developed and developing countries comes a growing need for convenient blood glucose monitoring, and convenient methods for analysis and treatment based on the monitoring. Diabetes patients need to monitor their blood glucose multiple times a day and record this information, which is analyzed, along with other parameters such as quantity of exercise and their diet, and then use the results to determine food intake, adjust the dosage of insulin and/or other therapeutic agent, and to recommended exercise intensity or cessation. Compliance with the monitoring, diet and exercise regimes is a challenge due to their complexity and temptation to avoid the recommended diet, which is low in simple sugars, and the recommended exercise regime.

A hand-held, portable wireless device, linked to and interactive with a server and with personal health monitors for the user, which can assist in compliance by reminding of the need to test periodically, logging the blood glucose test results and the associated meals, carbohydrates ingested and feelings, (and storing the results in a user friendly display form as averages and other analysis) providing selected educational messages, and providing sharing with select health monitors and other selected parties, would substantially increase compliance. A method of business based on such an interactive device, where the user pays monthly at a rate such that it is less costly than a conventional glucometer and the test strips for it, would be especially desired and needed.

### SUMMARY

The invention relates to a method of doing business based on a device which interacts with a server and with the user's health monitors (including physicians), and through these interactions guides the user to eat, exercise and test blood glucose and ketones so as to help maintain blood glucose (BG) and ketone levels at desirable levels, and also logs the results so the user can guide himself. The device is a wireless-linked (to the server) combination glucometer/accelerometer, which displays a series of user-interactive screens, having only a few icons per screen, which the user can selectively activate.

The user can activate an icon to accomplish one of several things, including:

Set alarm times and sounds to indicate that blood glucose should be tested and/or ketone levels should be tested, food should be consumed, or exercise should begin or end;

Place the device into airplane mode so as to not interfere with airline flight equipment during air travel;

confirm functioning of compatible glucose and ketone test strips against a control solution and calibrate the glucometer function against the control solution;

Set the pedometer/accelerometer to conform to the user's stride length, to displaying steps per designated unit of time, calories consumed per designated unit of time, total distance traveled per unit of time and average user speed;

Retrieve from the server and display messages relating to diabetes wellness education and suggested actions;

Permit user entry of the meal associated with a BG reading, whether the BG level was before or after a particular meal, the quantity of carbohydrate ingested at the meal, and the user's feelings near the meal;

Display BG values, including BG highs and lows, or average BG, over: designated time periods, before and after meals, and display the quantity of carbohydrate consumed at the meals and the user's feelings near the meal;

Display BG variation over time as a percentage of variance from the mean, and BG values as a percentage of a target BG, and also HB1Ac values and averages;

Read glucose or ketone test strips and display BG values, with a display of how to insert a test strip into the device and an automatic display indicating whether the test strip is correctly inserted;

Communicate results of BG and ketone testing, and user's steps, calories and distance traveled to a server, which can provide advice, including test BG or ketone levels again at a specified time, and educational messages based on said results;

Communicate said results to physicians and health monitors, who can alert the user or emergency services to problems;

Communicate said results to family members, and/or to personal devices of the user or others; and wherein the server also automatically communicates the following to the user:

Instruct ketone testing by the user if the BG is above 250 mg/dl;

Instruct the user to eat preferred foods if the user's BG tests below a specified level; and

Count the number of test strips consumed, and indicates when a significant number of strips have been consumed and more should be ordered; and

wherein the users are charged for using the interactive system such that the cost of the complete interactive service including the device and blood glucose and ketone test strips, is less than cost for the competitor's blood glucose test strips alone during the same period.

The device can also provide progressive personalization of food and exercise choices, including finding foods of the same families and characteristics as foods the user chooses or indicates are preferred, wherein food characteristics can include texture, color, softness, tartness, sweetness, degree of spicy, meaty, fruity, mushy, oily or firm.

In addition to automatically counting the number of test strips consumed, the device can automatically indicate when it is time to order more test strips, and can provide for automatic strip ordering from the device by activating an icon.

The device also provides educational messages and summaries of BG levels automatically, for example during or following BG testing. The educational messages and automatic messages are based on the BG results. For example, instructions to ketone test are automatically triggered if the BG is above 250 mg/dl. And a message to eat preferred foods, like vegetables, appears if the BG is low. The messages displayed can also depend on other factors like the user's reported feelings or quantity of carbohydrate consumed.

In one embodiment, a business method is based on the device, wherein the device and the wireless services available through the device are priced so that the service is less than test strips alone on a monthly basis (as sold by competitors). Current business models associated with the glucometer field are to heavily discount the glucometer, then sell test strips to the consumer.

Other features of the device are described below.

### BRIEF DESCRIPTION OF THE DRAWINGS

FIG. 1 depicts the initial screen display on starting the device.

FIG. 2 depicts the home screen and six icons, each of which can be activated by the user.

FIG. 3 depicts the home screen of FIG. 2 with the Settings icon being activated by the user.

FIG. 4 depicts the settings screen display following activation as in FIG. 3.

FIG. 5 depicts the settings screen of FIG. 4 with the Help icon activated.

FIG. 6 depicts the help screen display, following activation as in FIG. 5.

FIG. 7 depicts the settings screen with the About icon activated.

FIG. 8 depicts the About screen display, following activation as in FIG. 7.

FIG. 9 depicts the settings screen with the Airplane icon activated.

FIG. 10 depicts the Airplane mode screen with the On icon activated.

FIG. 11 depicts the Airplane mode screen with the icon activated to release the device from airplane mode and return to the settings screen.

FIG. 12 depicts the settings screen with the Accelerometer icon activated.

FIG. 13 depicts the Accelerometer screen, following activation as in FIG. 12, where the length of stride of the user is indicated.

FIG. 14 depicts the settings screen with the Calibrate-Control icon activated.

FIG. 15 depicts the first image instructing the user on use of the control solution and test strips, following activation of the Calibrate-Control icon in FIG. 14.

FIG. 16 depicts the next image after FIG. 15, instructing the user on use of the control solution and calibration procedure, following activation of the Calibrate-Control icon in FIG. 14.

FIG. 17 depicts the image indicating that checking blood glucose control solution is in progress.

FIG. 18 depicts the image indicating that checking blood glucose control solution is complete.

FIG. 19 is the image indicating that checking ketones is in progress.

FIG. 20 indicates the ketone concentration is 1 mmol/l, following checking.

FIG. 21 depicts the settings screen with the Sounds & Alarms icon activated.

FIG. 22 depicts the screen where sounds and alarms can be set.

FIG. 23 depicts the screen of FIG. 22 with the Alarm setting icon activated.

FIG. 24 depicts the Alarm settings screen with the alarm set for 8:00 AM, with the alarm hour settings shown.

FIG. 25 depicts the Alarm settings screen with the alarm set for 8:00 AM, with the alarm minute settings shown.

FIG. 26 depicts the Alarm settings screen with the alarm set for 8:00 AM, with the AM/PM settings shown.

FIG. 27 depicts the Alarm settings screen with the alarm set for 8:00 AM, with the settings for turning the alarm on or off, or setting it for weekdays, shown.

FIG. 28 depicts the Alarm settings screen with the alarm set for 8:00 AM, with the settings for turning the alarm on, setting it for weekdays or setting it for one time only, shown.

FIG. 29 depicts the Alarm settings screen and shows that at least three alarm events can be set.

FIG. 30 depicts the settings screen with the accelerometer icon activated.

FIG. 31 depicts the screen showing the total steps for the day, calories expended and distance traveled.

FIG. 32 depicts the screen allowing the user to measure, in a time period set by the user, the number of steps, calories expended, distance traveled and average speed.

FIG. 33 depicts the screen of FIG. 32, and shows that the time period can be reset by the user, using the Reset icon.

FIG. 34 depicts the settings screen with the check blood glucose icon activated.

FIG. 35 depicts the first image instructing the user to insert the glucose test strip, following activation as in FIG. 34.

FIG. 36 depicts the next image indicating the device is ready to check blood glucose, following the image in FIG. 35.

FIG. 37 depicts the screen showing that the blood glucose checking is in progress.

FIG. 38 depicts the screen showing the blood glucose reading as determined by the device.

FIG. 39 depicts the screen in FIG. 38 and indicates the user associated the blood glucose reading with “After Breakfast” and that the user wants to associate the quantity of carbohydrate consumed at breakfast with the reading.

FIG. 40 depicts the screen where the quantity of carbohydrate consumed at breakfast is to be entered.

FIG. 41 depicts the screen where the user enters that 35 grams of carbohydrate were consumed at breakfast.

FIG. 42 depicts the screen where the user's feelings can be associated with the blood glucose reading.

FIG. 43 depicts that the blood glucose data from the device is being uploading to the server.

FIG. 44 depicts that the data upload in FIG. 43 is completed.

FIG. 45 depicts an educational message from the server based on the blood glucose reading uploaded in FIG. 44.

FIG. 46 depicts the screen showing the blood glucose reading (above 250 mg/dl) as determined by the device.

FIG. 47 depicts the screen in FIG. 46 and indicates the user associated the blood glucose reading with “After Lunch” and that the user wants to associate the quantity of carbohydrate consumed at lunch with the reading.

FIG. 48 depicts the screen where the user enters that 35 grams of carbohydrate were consumed at lunch.

FIG. 49 depicts the screen showing the blood glucose reading (above 250 mg/dl) as determined by the device.

FIG. 50 depicts the screen instructing the user to insert a ketone test strip, based on the blood glucose reading above 250 mg/dl.

FIG. 51 depicts the screen indicating the device is ready to check ketones.

FIG. 52 depicts the screen indicating the ketone test strip is properly inserted and the ketone checking is in progress.

FIG. 53 depicts the screen showing the results of ketone testing.

FIG. 54 depicts ketone test results from the device are being uploading to the server.

FIG. 55 depicts that the data upload in FIG. 54 is completed.

FIG. 56 depicts the home screen and six icons, each of which can be activated by the user.

FIG. 57 depicts that the Trends icon on the home screen is being activated.

FIG. 58 depicts the Trends display of the device.

FIG. 59 depicts the display of the device following activation of the Logbook icon in FIG. 58.

FIG. 60 depicts the display of the device following activation of the April 30 icon in FIG. 59, showing data for that day.

FIG. 61 depicts the display showing the data from FIG. 60 in graphical representation.

FIG. 62 depicts the display showing the blood glucose level data from April 30 to May 6, before and after each of the three major meals, with the icon activated indicating the user wants to view additional data relating to breakfast.

FIG. 63 depicts the display showing the blood glucose level data from April 30 to May 6, before and after breakfast, and also showing the quantity of carbohydrate ingested at each breakfast and the patient's feelings at each breakfast.

FIG. 64 depicts the display showing the blood glucose level data from April 30 to May 6, before and after each of the three major meals, with the icon activated indicating the user wants to view additional data relating to lunch.

FIG. 65 depicts the display showing the blood glucose level data from April 30 to May 6, before and after lunch, and also showing the quantity of carbohydrate ingested at each lunch and the patient's feelings at each lunch.

FIG. 66 depicts the display showing the blood glucose level data from April 30 to May 6, before and after each of the three major meals, with the icon activated indicating the user wants to view additional data relating to dinner.

FIG. 67 depicts the display showing the blood glucose level data from April 30 to May 6, before and after dinner, and also showing the quantity of carbohydrate ingested at each dinner and the patient's feelings at each dinner.

FIG. 68 depicts the display showing the blood glucose level data from April 30 to May 6, before and after a snack, and also showing the quantity of carbohydrate ingested at each snack and the patient's feelings at each snack.

FIG. 69 depicts the display showing the patterns and statistics over seven days, both before and after meals, and showing average blood glucose levels, highs, lows, percentage of variance of the mean, and percent of goal.

FIG. 70 depicts the display showing the average blood glucose level at breakfast over the prior seven, fourteen, sixty and ninety days, respectively.

FIG. 71 is the same view as FIG. 69 (what icons should be shown depressed—I think “high” and 90 days)??

FIG. 72 depicts the display showing the high blood glucose levels over the past 90 days, the associated meal, whether the level was before or after the associated meal, and the user's feelings.

FIG. 73 is the same view as FIG. 69 but where the icons “low” and “90 days” have been activated.

FIG. 74 depicts the display showing the low blood glucose levels over the past 90 days, the associated meal, whether the level was before or after the associated meal, and the user's feelings.

FIG. 75 depicts the display showing the patterns and statistics over seven days, both before and after meals, and showing average blood glucose levels, highs, lows, percentage of variance of the mean, and percent of goal.

FIG. 76 shows a similar display to FIG. 75.

FIG. 77 depicts the display showing the patterns and statistics over seven days, both before and after meals, and showing average blood glucose levels, highs, lows, percentage of variance of the mean, and percent of goal.

FIG. 78 depicts the display showing the summary of the user's steps and calories over the prior week, with the icons depressed indicating the data should be displayed for May 5.

FIG. 79 depicts the display showing the breakdown of the user's steps over course of one day.

FIG. 80 depicts the display showing the user's average daily steps over the prior week in graphical form.

FIG. 81 depicts the display showing, over 30 days, the average, high and low blood glucose levels, percent variance, percent of goal, Hb1Ac, and the average daily number of steps, with the high and low number of daily steps shown as well.

FIG. 82 depicts the home screen with the messages icon activated.

FIG. 83 depicts the display showing the messages to the user, including the number of strips the user has left, where the user can activate an icon to order more strips

FIG. 84 depicts the display showing the number of strips the user has left.

FIG. 85 depicts the display showing the number of strips the user has left, where the user can activate an icon to order more strips or an icon to invite a telephone call relating to ordering strips.

FIG. 86 depicts the screen showing the number of strips the user has left, where the user can activate an icon to order more strips.

FIG. 87 depicts the home screen with the Team icon activated.

FIG. 88 depicts the display following activation of the Team icon, with the MyCoach icon activated.

FIG. 89 depicts the display when the device is sending data which can be viewed by the parties designated as MyCoach.

FIG. 90 depicts the display following activation of the Team icon, with the MyMD icon activated.

FIG. 91 depicts the display when the device is sending data which can be viewed by the parties designated as MyMD.

FIG. 92 depicts the display when the device is sending data as an SMS message which can be viewed by the parties designated as MyMD.

FIG. 93 depicts the display when the device is sending data which can be viewed by the parties designated as MyMD.

FIG. 94 depicts the display allowing data to be sent by email or fax.

FIG. 95 depicts the display following activation of the Team icon, with the MyFamily icon activated.

FIG. 96 depicts the display when the device is sending data which can be viewed by the parties designated as MyFamily.

FIG. 97 depicts the display following activation of the Team icon, with the MyMobile icon activated.

FIG. 98 depicts the display when the device is sending data which can be viewed through a designated mobile phone as an SMS message.

FIG. 99 depicts the display when the blood glucose strip has been inserted with an insufficient blood sample for testing.

FIG. 100 depicts the display when the device battery is fully charged.

FIG. 101 depicts the display when the device battery is about ¾ charged.

FIG. 102 depicts the display when the device battery is about ½ charged.

FIG. 103 depicts the display when the device battery is about ¼ charged.

FIG. 104 depicts the display indicating the device battery is charging.

FIG. 105 depicts the display indicating the device is shutting down.

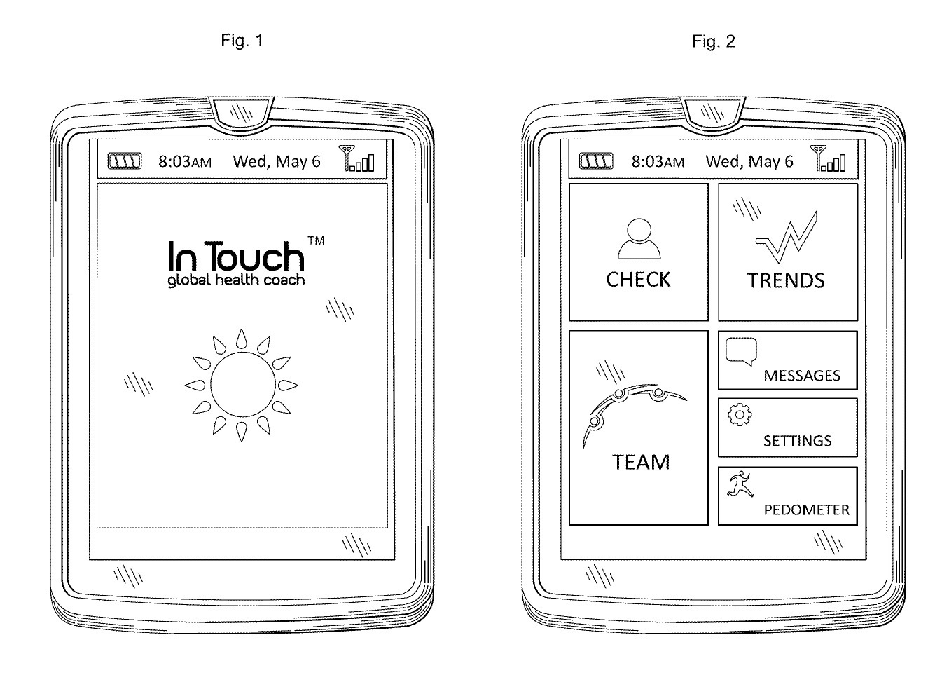

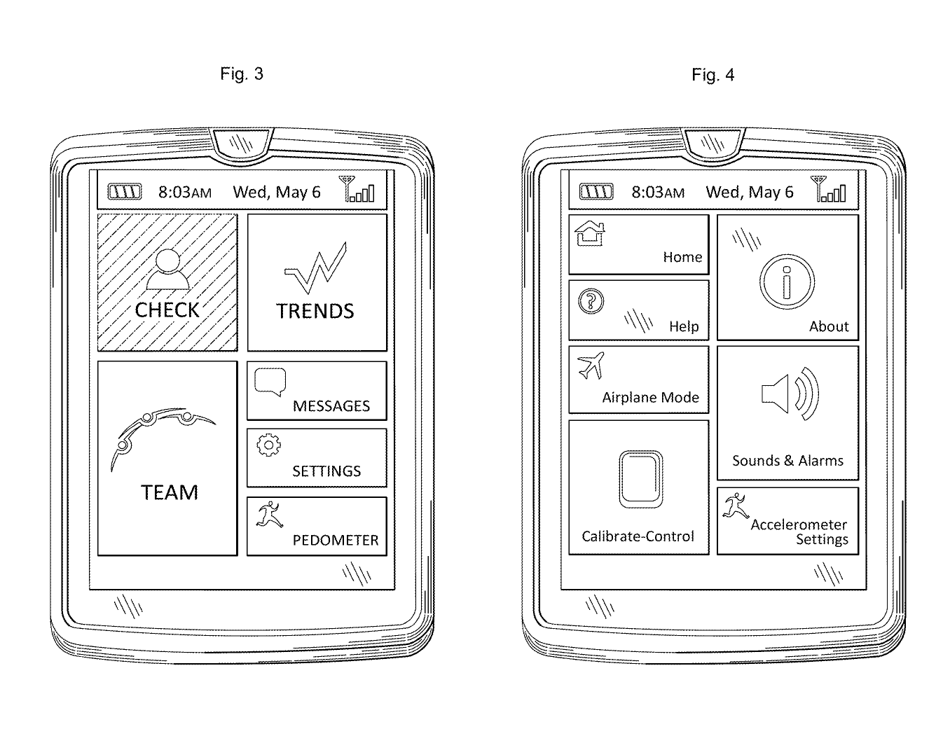

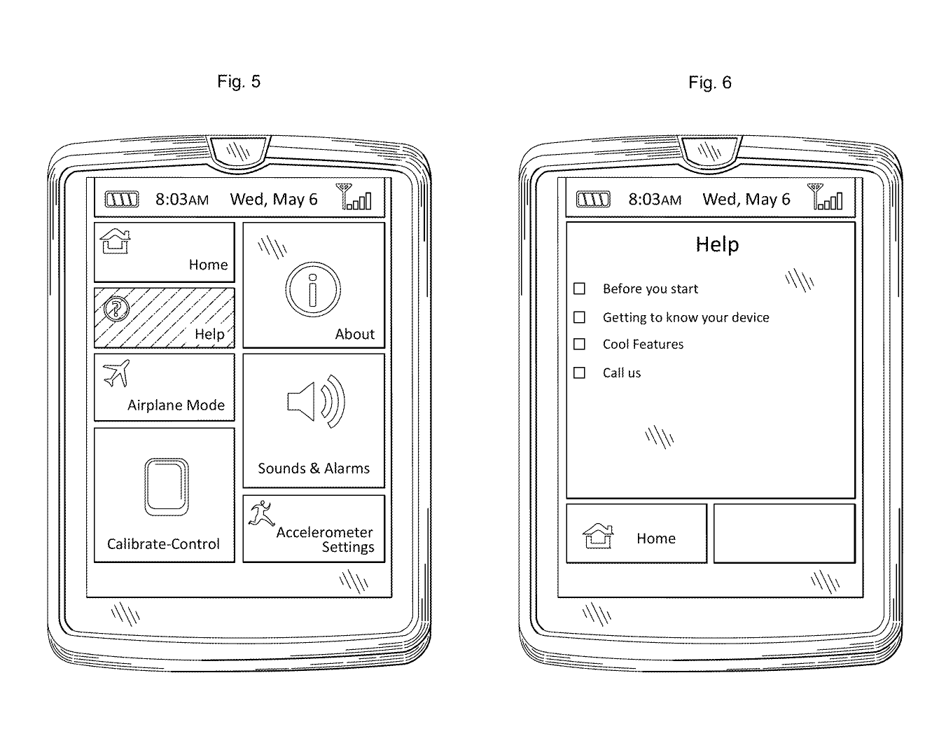

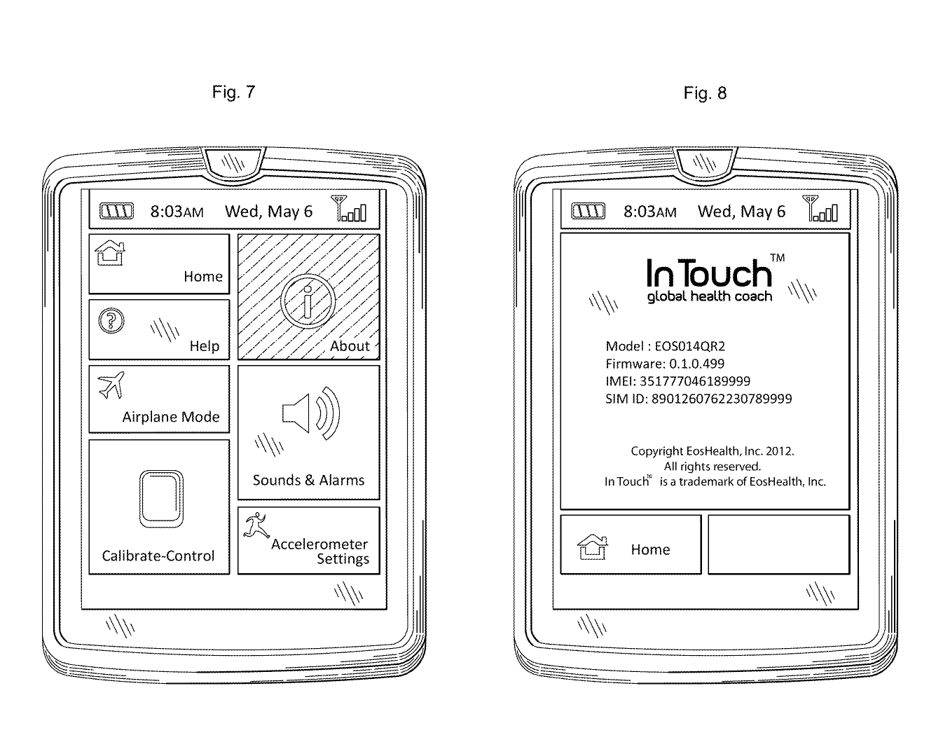

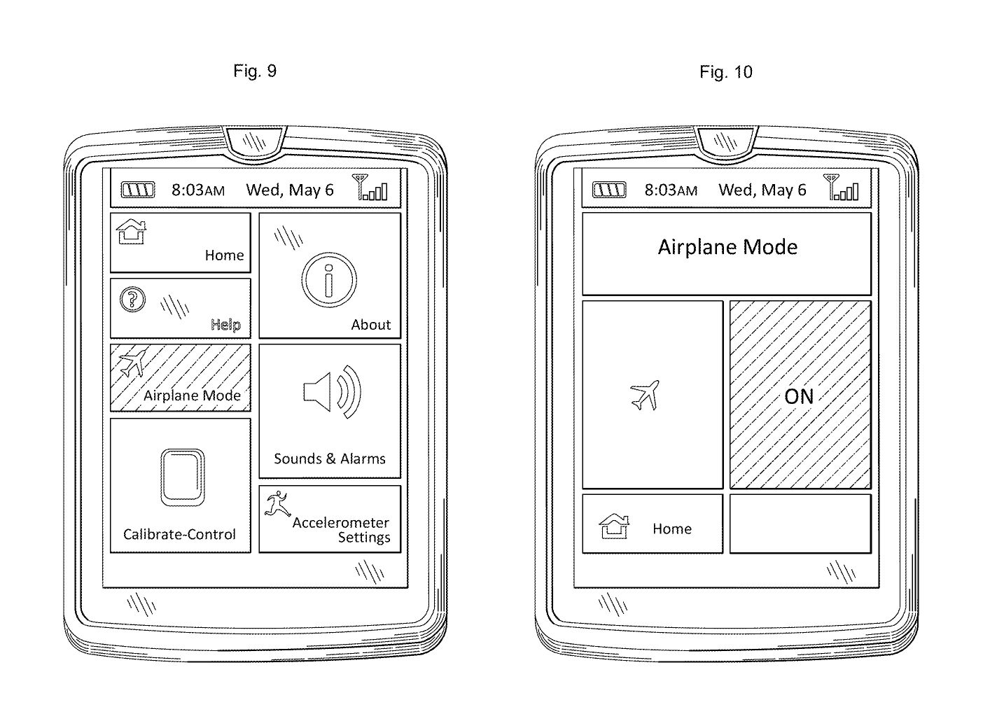

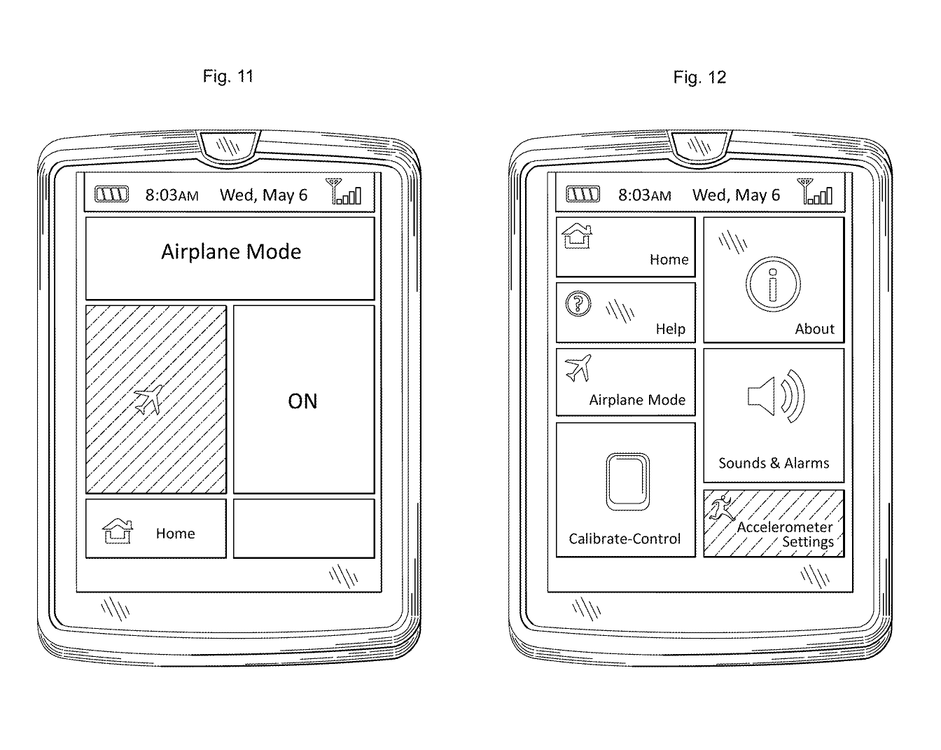

### DETAILED DESCRIPTION

The method herein includes a service plan where the interactive wireless device, with BG and ketone test strips, is supplied to the end user. But service plans can also be purchased by employers, Pharmacy benefit managers (PBM), health plans, Accountable Care Organizations (ACOs), diabetes management services and physician groups, for their employees or members. The complete service plan provides a vastly improved standard of care for diabetics, who can readily review their own activities, food choices, insulin and drug administration, and corresponding BG and ketone levels, to determine what exercise, foods and drug administration provide optimal results. They also have the benefit of receiving educational messages and warning messages from the server or from health monitors, based on BG, ketone levels and other transmitted information. The service plan is less expensive than the cost of strips because the device incorporates a glucometer which does not need to consume the conventional high cost test strips.

The wireless glucometer, ketone analyzer and accelerometer is the heart of the system for improved patient care and outcomes. The device is icon driven, with few icons per screen and few printed instructions per screen, for ease of reading and ease of use. User compliance is increased by having an easy to use and device which provides readily comprehensible instructions and education, and various summaries of important parameters for diabetics to assist in control of their disease.

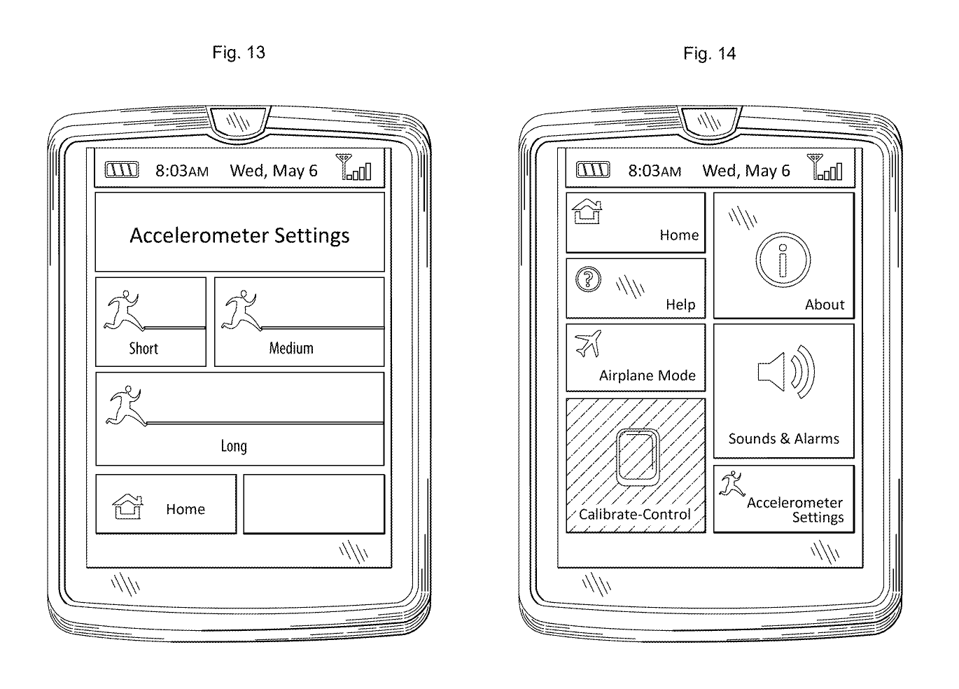

The description and display of the introductory screens (1 to 11) is sufficient in the Brief Description of the Drawings section to understand their operation. The accelerometer activated as in FIG. 12 to display the image as in FIG. 13, is preferably a three-axis preferred accelerometer as described and claimed in U.S. Pat. No. 8,066,640, incorporated by reference. In FIG. 13 the user can indicate the length of his/her stride, to assist the accelerometer in more accurately tracking distance traveled and calories expended during exercise.

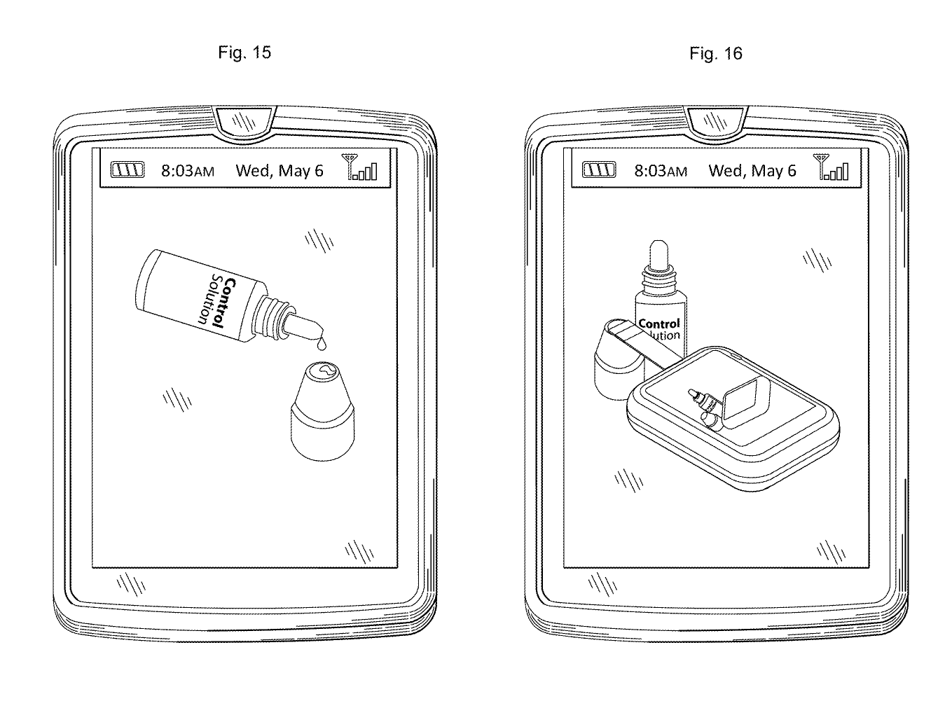

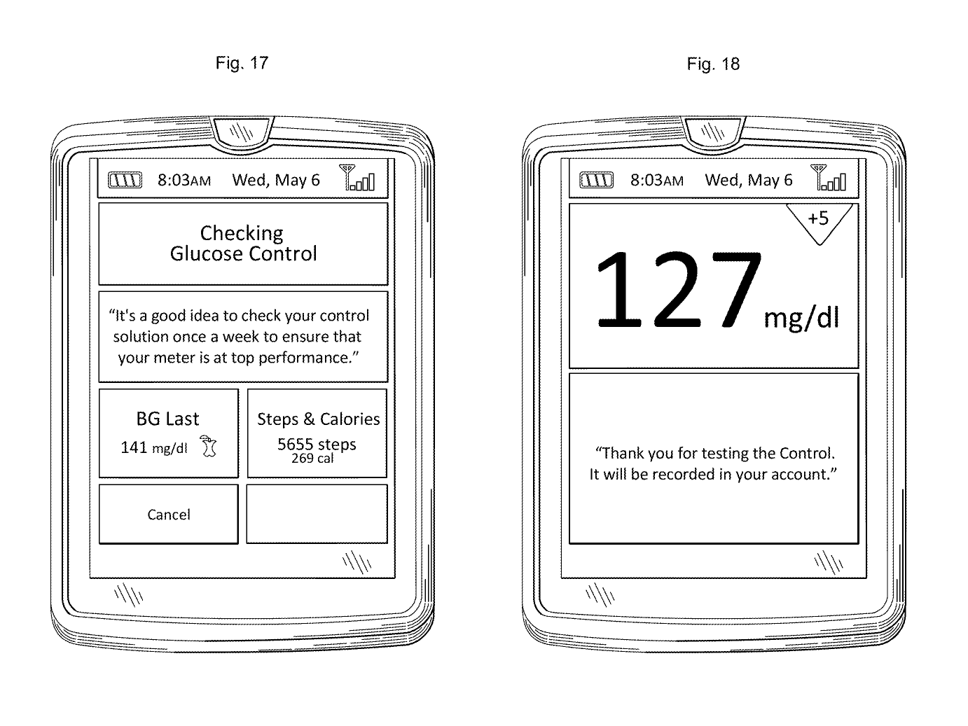

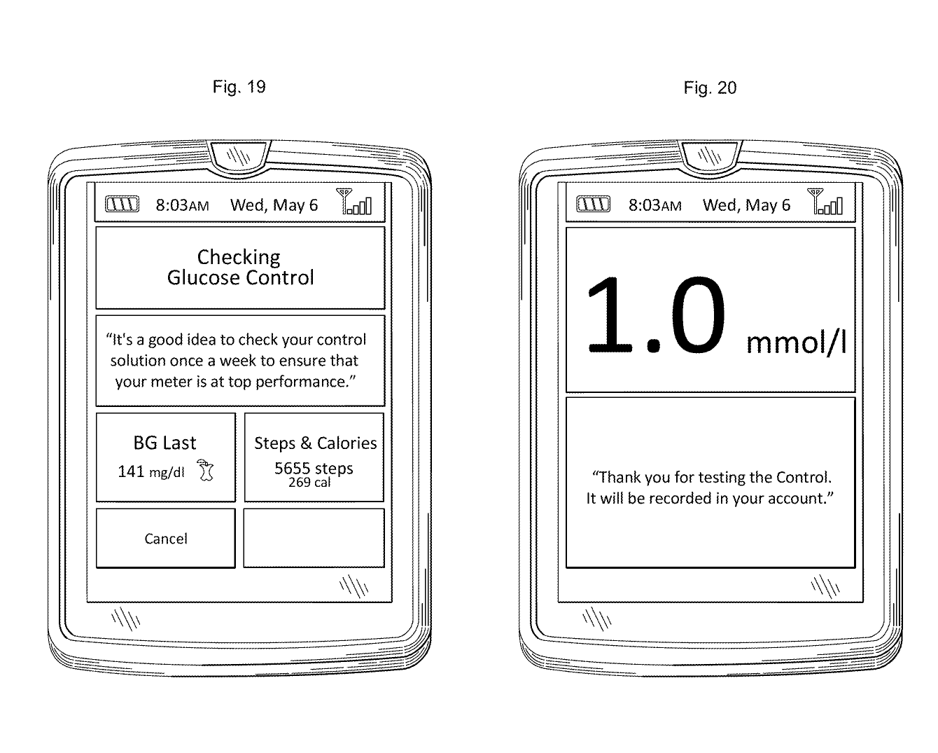

FIGS. 14 to 18 depict a set of screens for calibrating and confirm functioning of the device-compatible glucose test strips, which generates a particular simulated BG level on contact with the test strip. The device glucometer then calibrates itself automatically against the control results, to ensure patient BG and ketone readings are accurate. Although not shown, ketone test strips and the function of the device ketone tester could also be confirmed and calibrated against a ketone test solution, using a similar set of instructional screens. FIGS. 19 and 20 depict checking of ketones, where the results of the testing are 1 mmol/l.

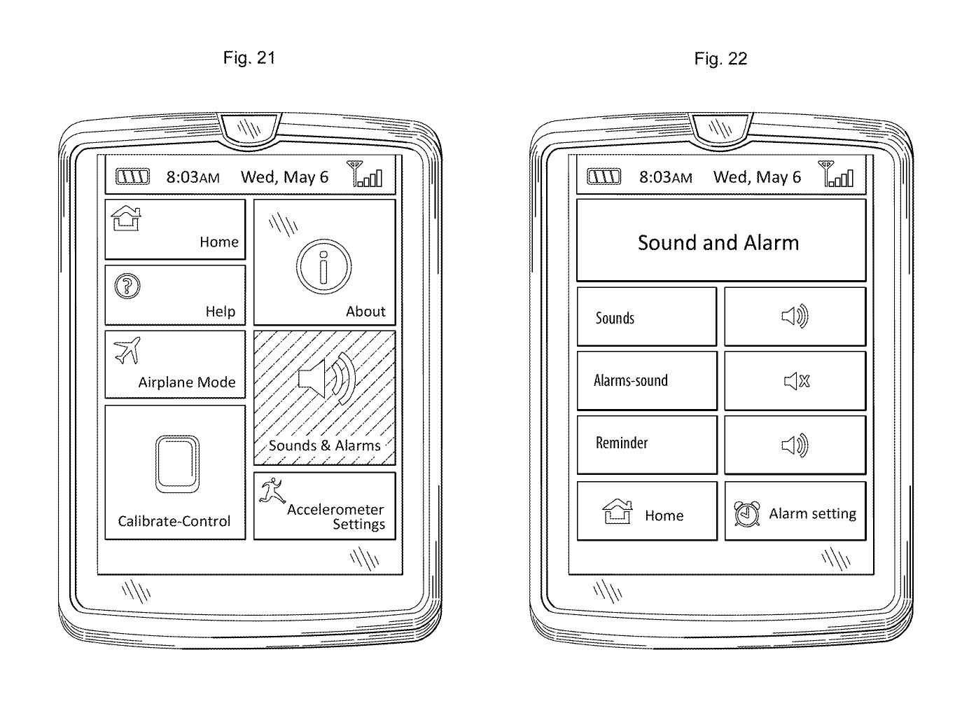

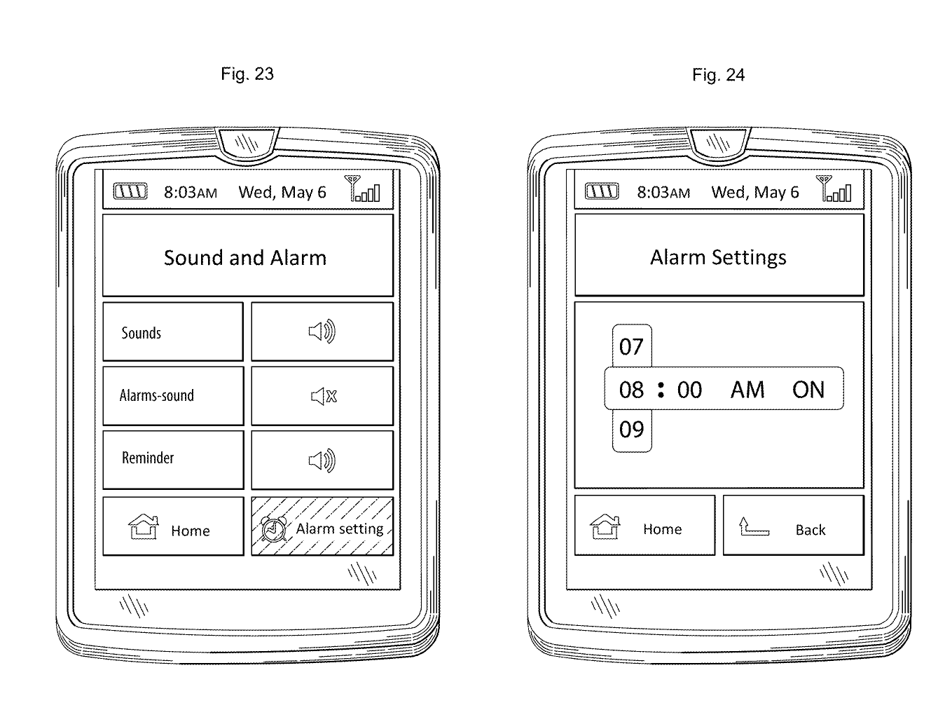

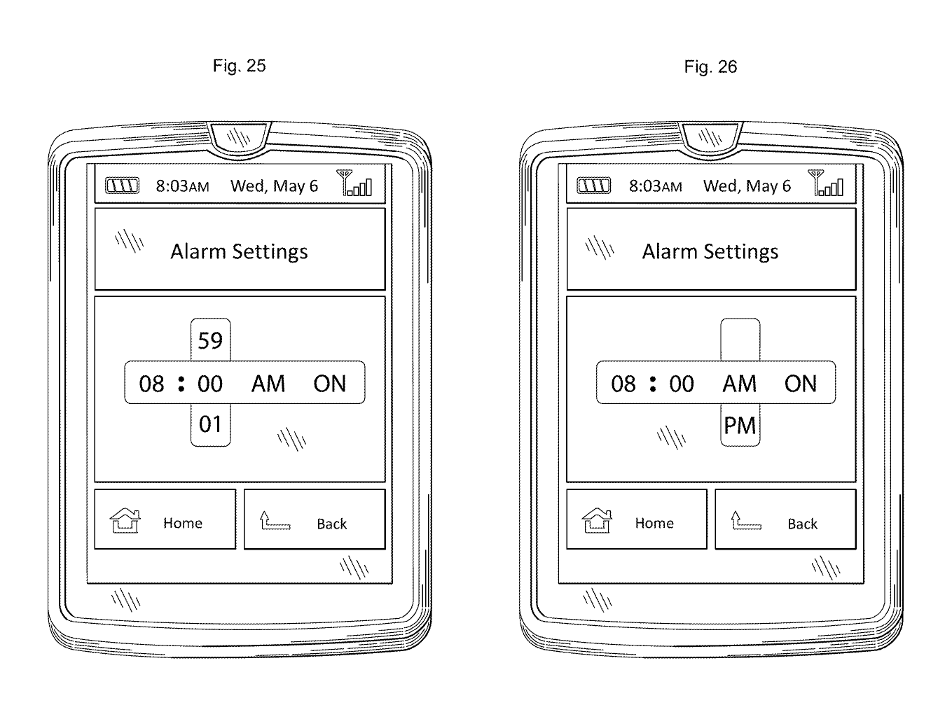

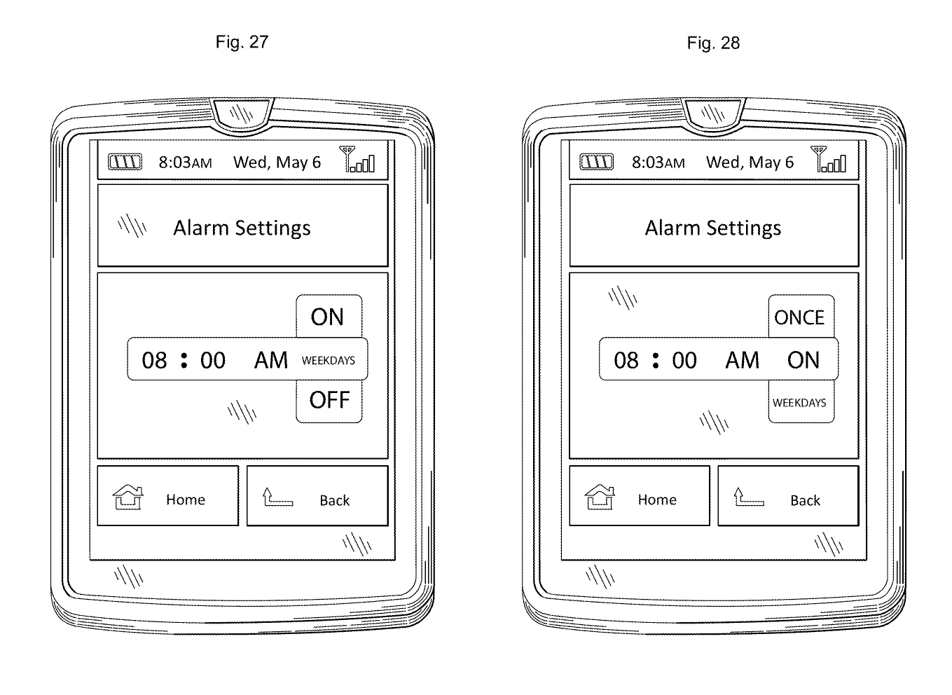

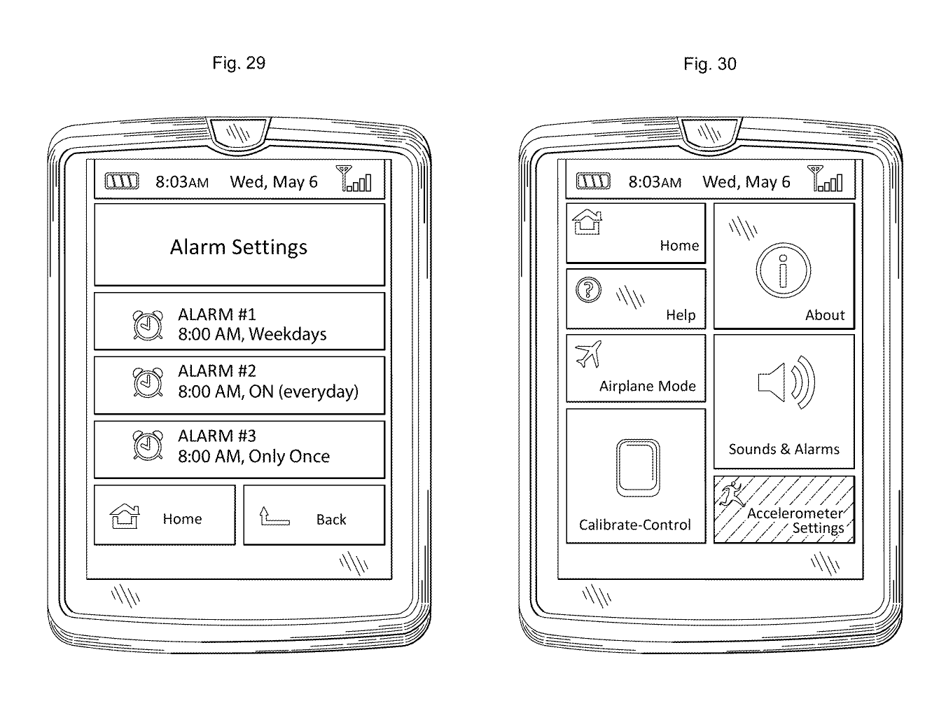

FIGS. 21 to 29 depict the screens which allows the user to set health-related alarms on the device. The device allows the user to set multiple alarms, alarms daily or weekdays only, or weekends only, and to have different sounds associated with different alarms. The alarms can indicate, for example, when a user is to check BG levels, eat, exercise or administer insulin or other drugs.

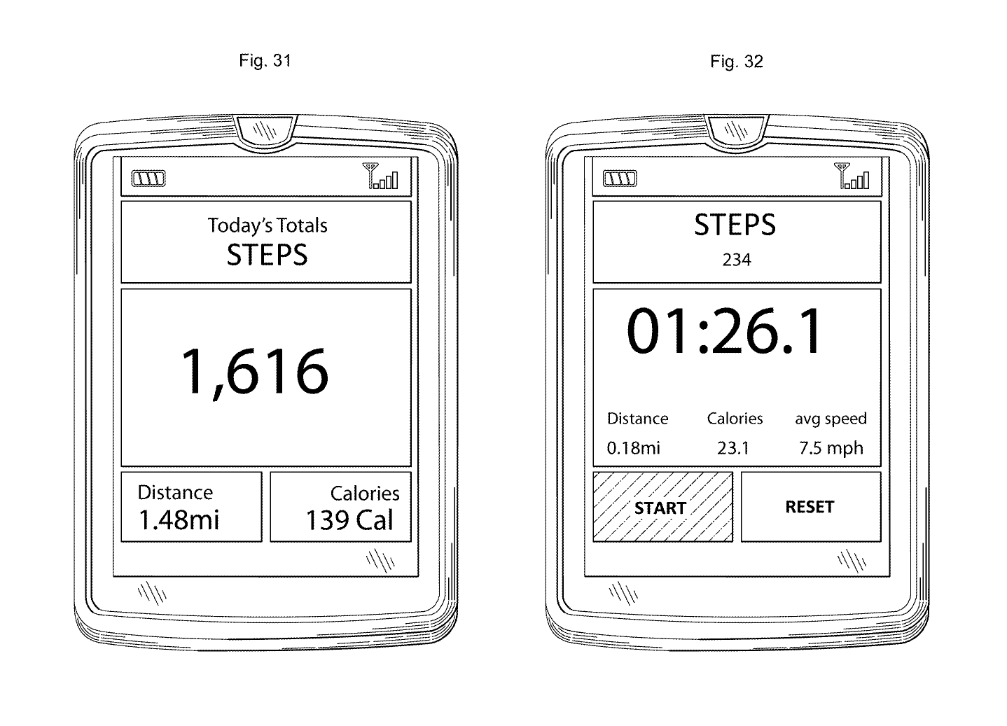

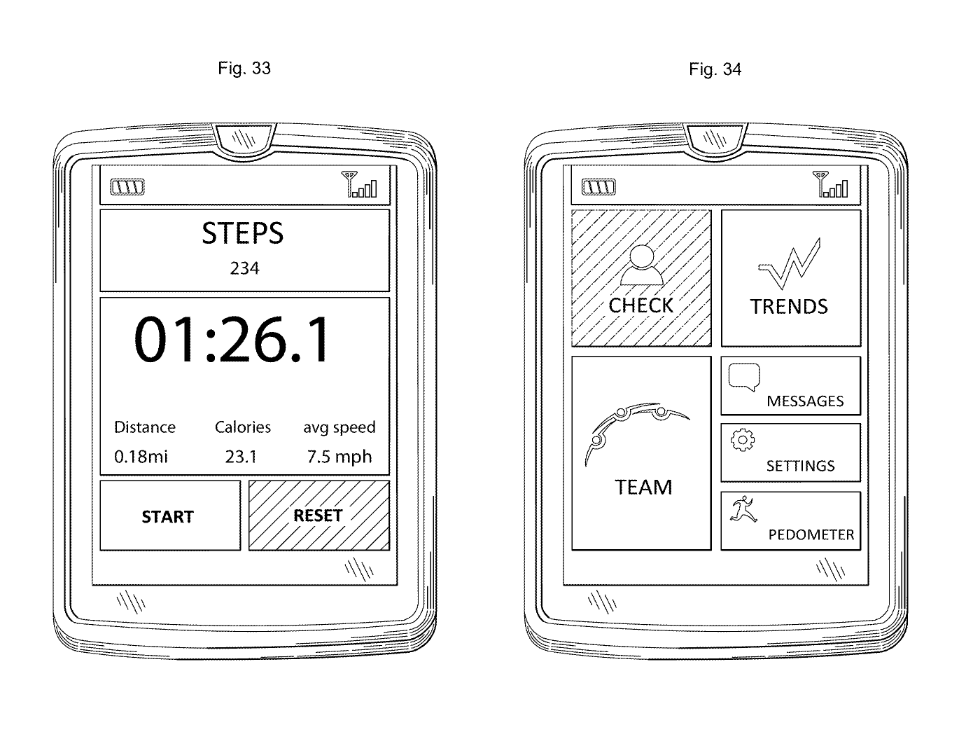

FIGS. 30 to 33 depict the screens associated with the accelerometer, and the logging of the user's daily steps, calories expended, distance traveled and average speed. The accelerometer can be reset (using the reset icon in FIG. 33) and then started manually (as in FIG. 32) to log the steps, calories expended, distance traveled and average speed over a user-set period. This allows the user to determine exertion level when the user engages in, for example, running vs. jogging vs. walking during a defined period.

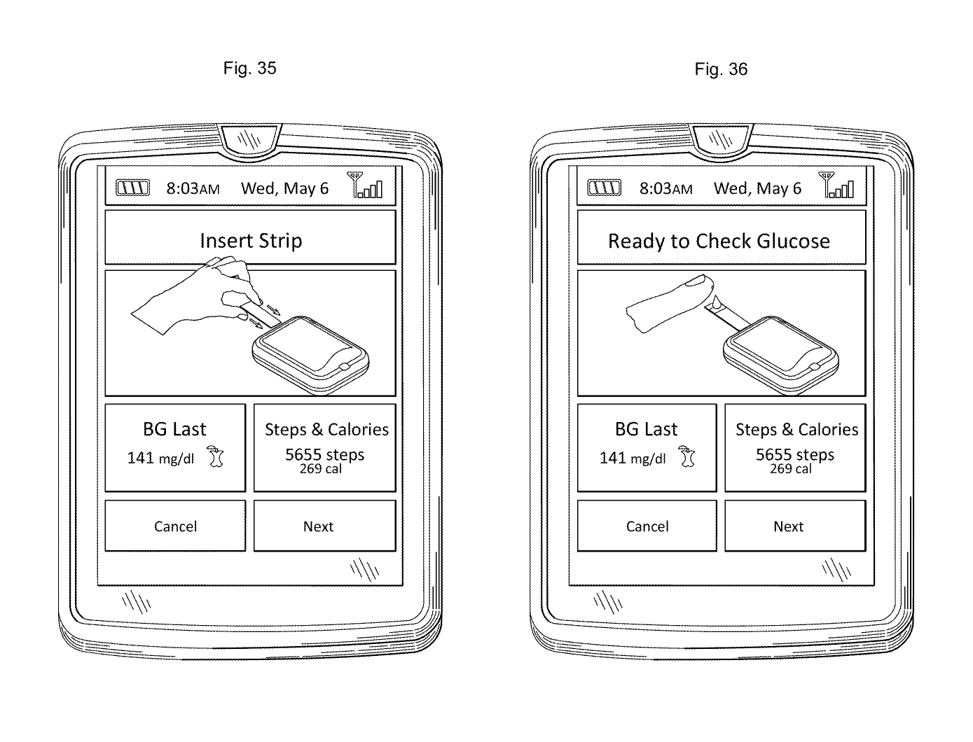

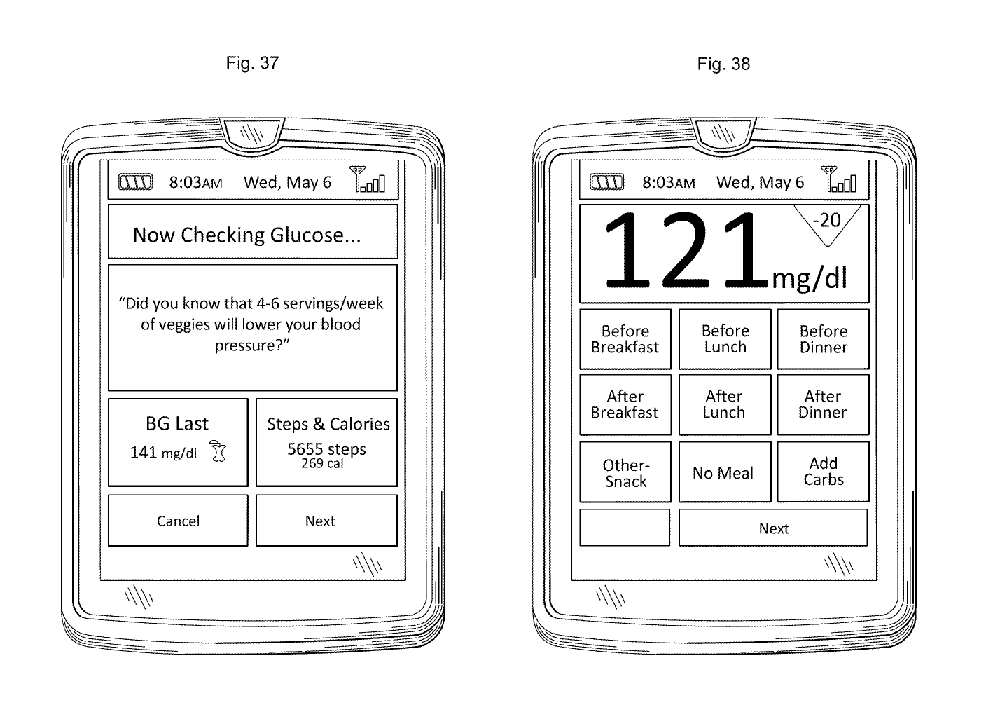

FIGS. 34 to 38 depict the displays when the user activates the icon indicating he/she will checking BG. FIGS. 35 and 36 depict the display instructing strip insertion and also showing that the strip is properly inserted. The screens show the immediately prior BG reading and the user's steps that day and calories expended that day. On screen 37, an exemplary education message for the user is displayed, stating: “Did you know that 4-6 servings/week of veggies will lower your blood pressure?”

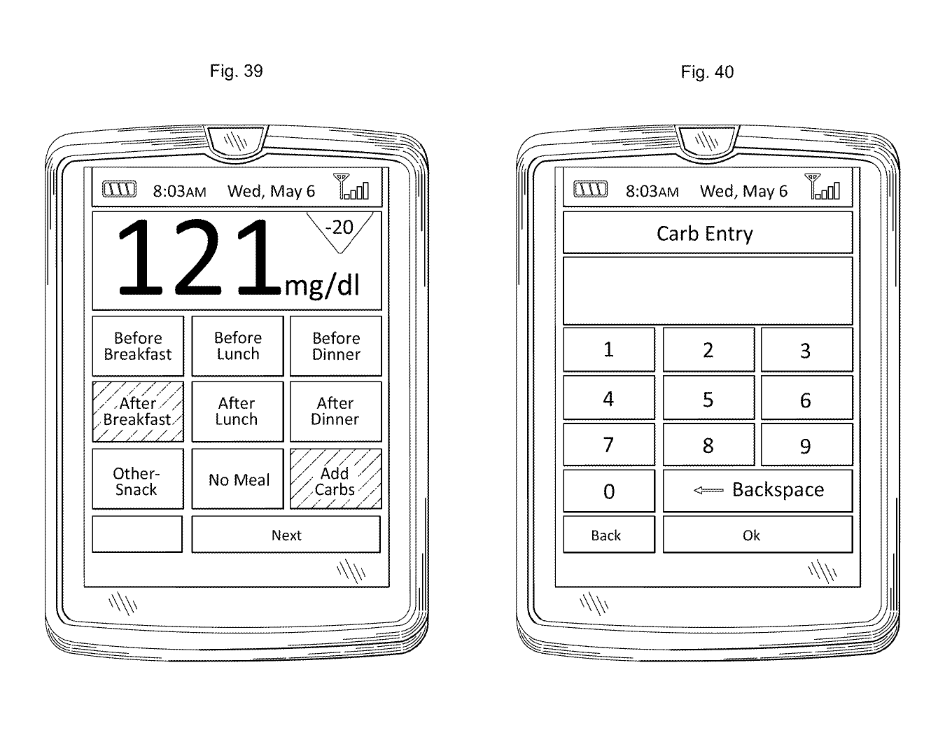

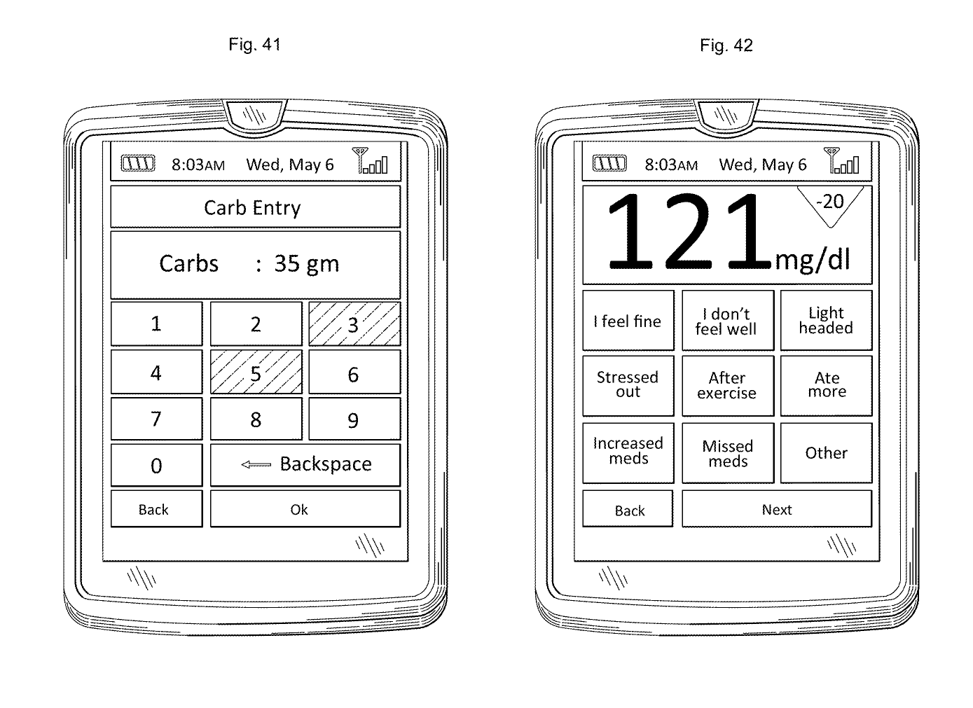

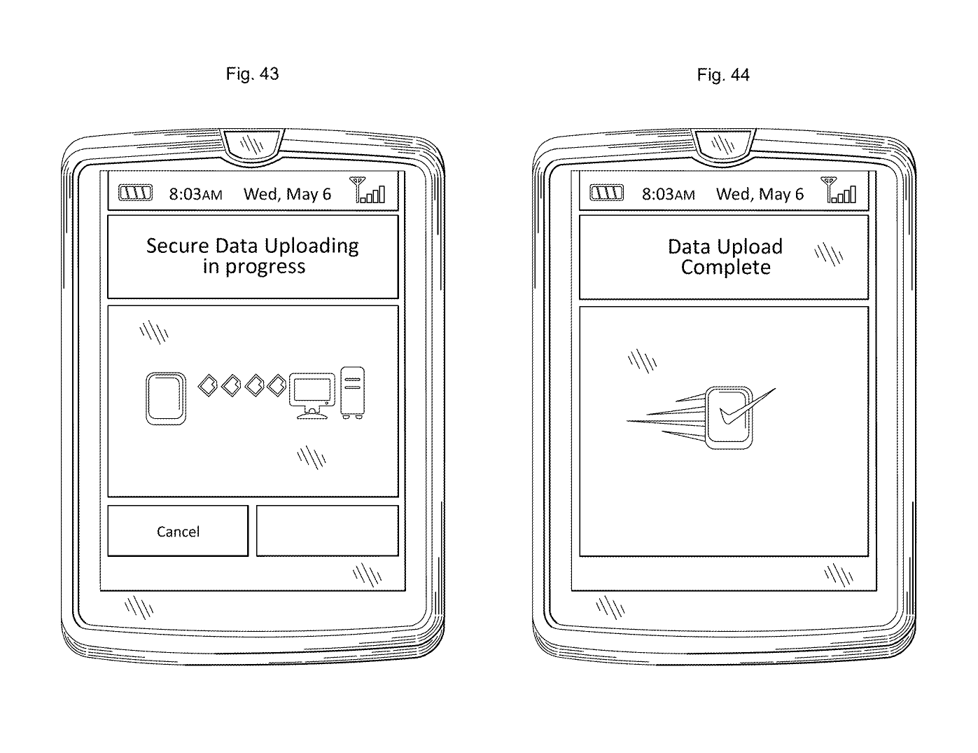

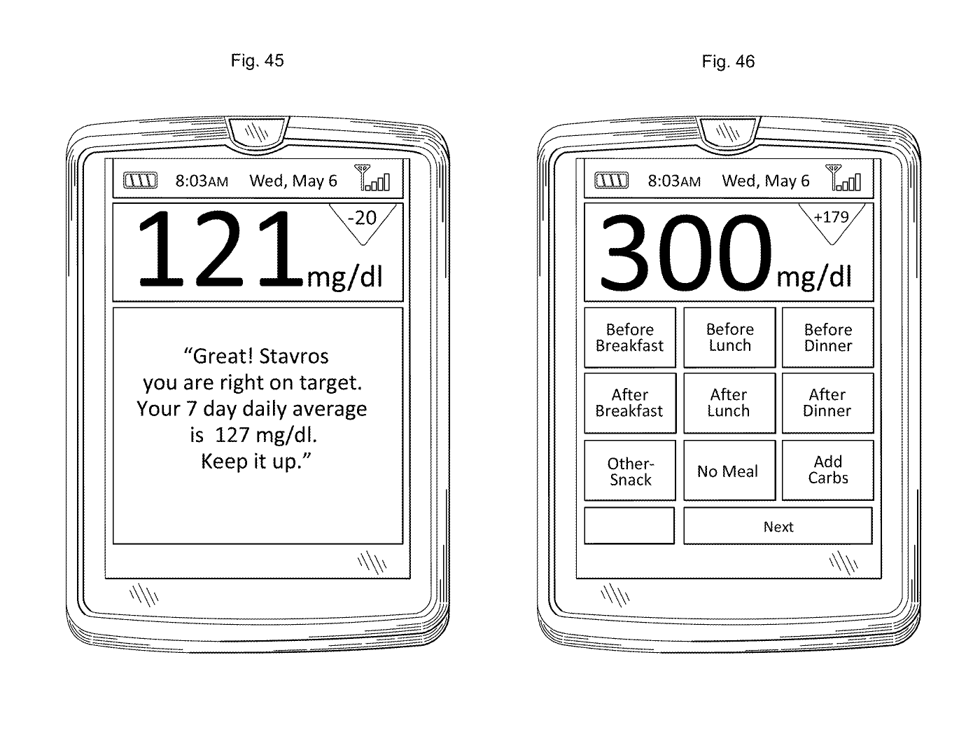

FIG. 39 shows the screen allowing associating the test result (BG reading) with respect to whether it was before or after a particular meal. FIG. 39 also shows the “Add Carbs” icon activated, and FIG. 40-41 shows that the user can indicate he took in 35 grams of carbohydrate at breakfast. FIG. 42 shows the screen where the user can associate his health-related feelings with the BG reading, and also can indicate if the BG test was after exercise. FIG. 43 depicts the screen indicating the BG reading and other input is being uploaded to the server, and FIG. 44 indicates the uploading has been completed. FIG. 45 shows the screen with the BG reading displayed, and an exemplary message summarizing the week's prior averaged BG readings and indicating the user's BG is well-controlled over such period.

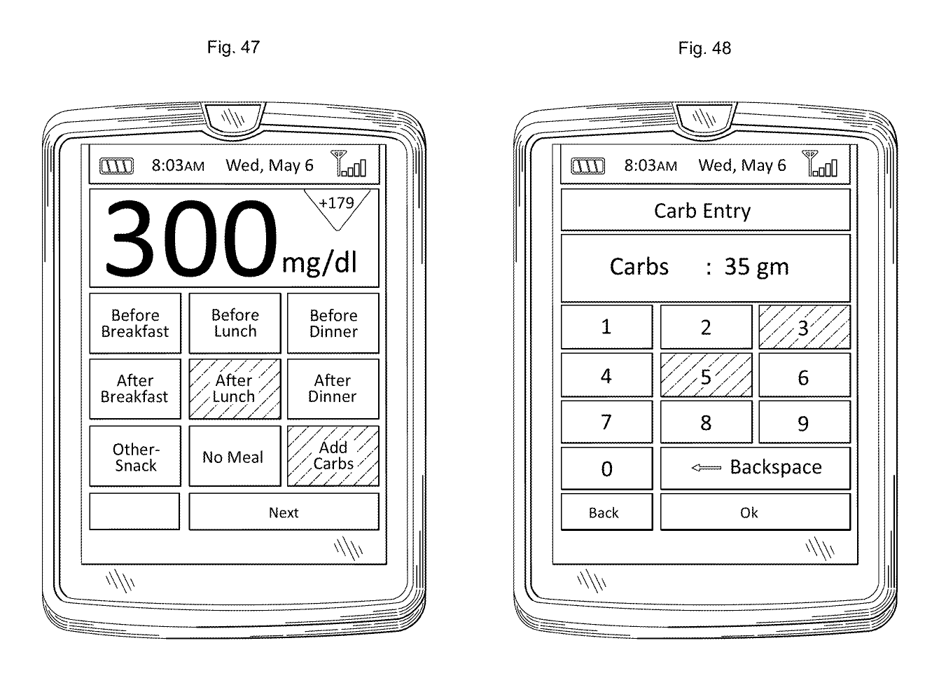

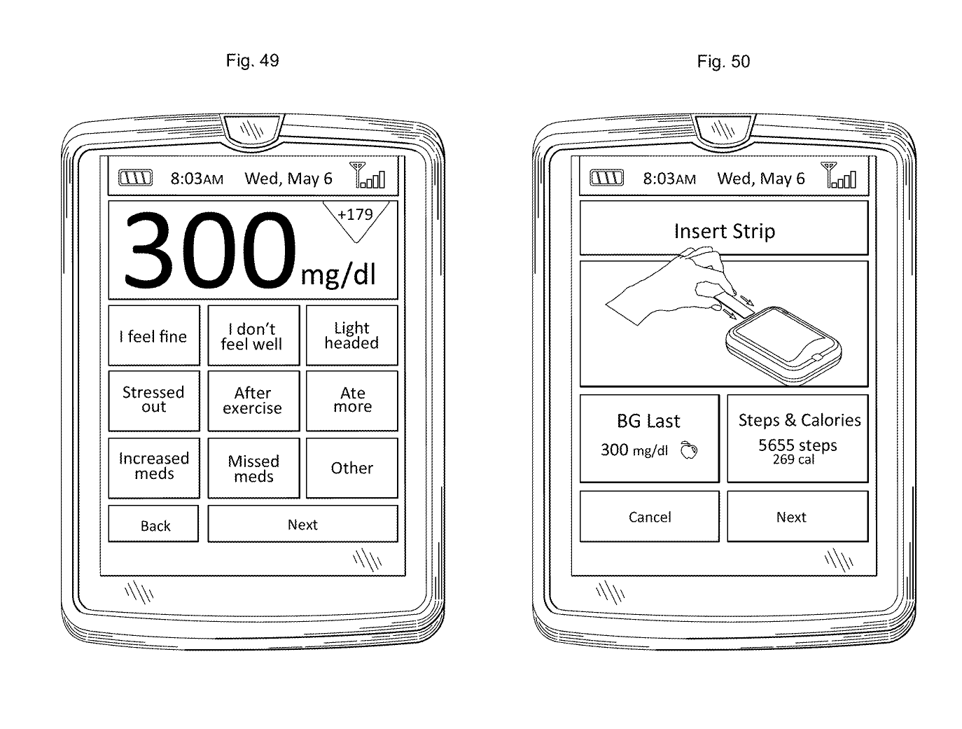

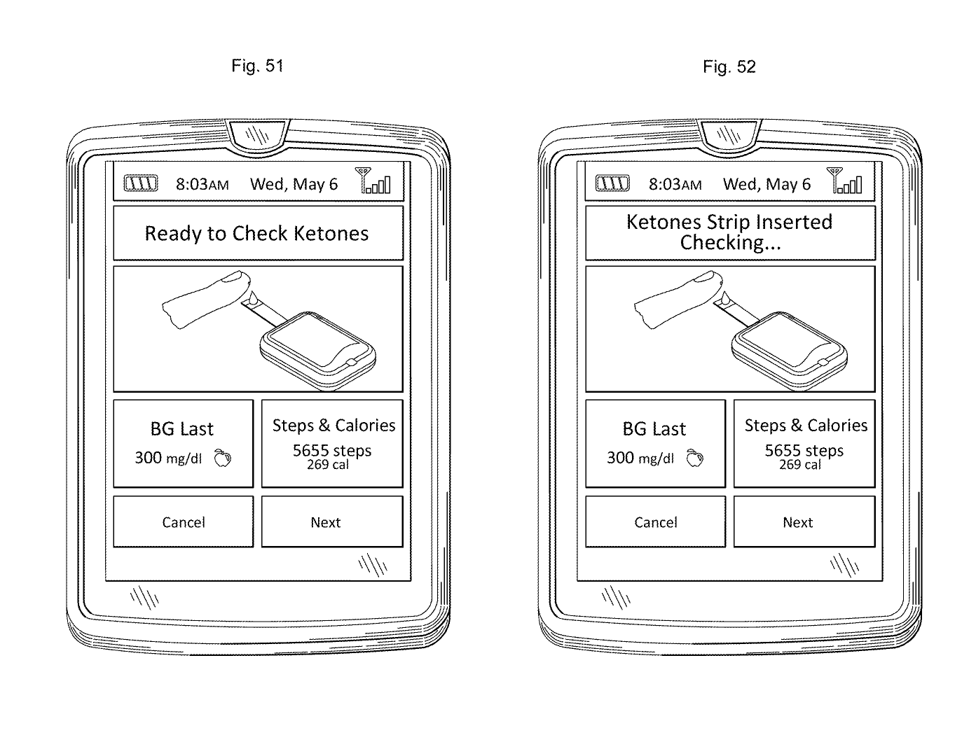

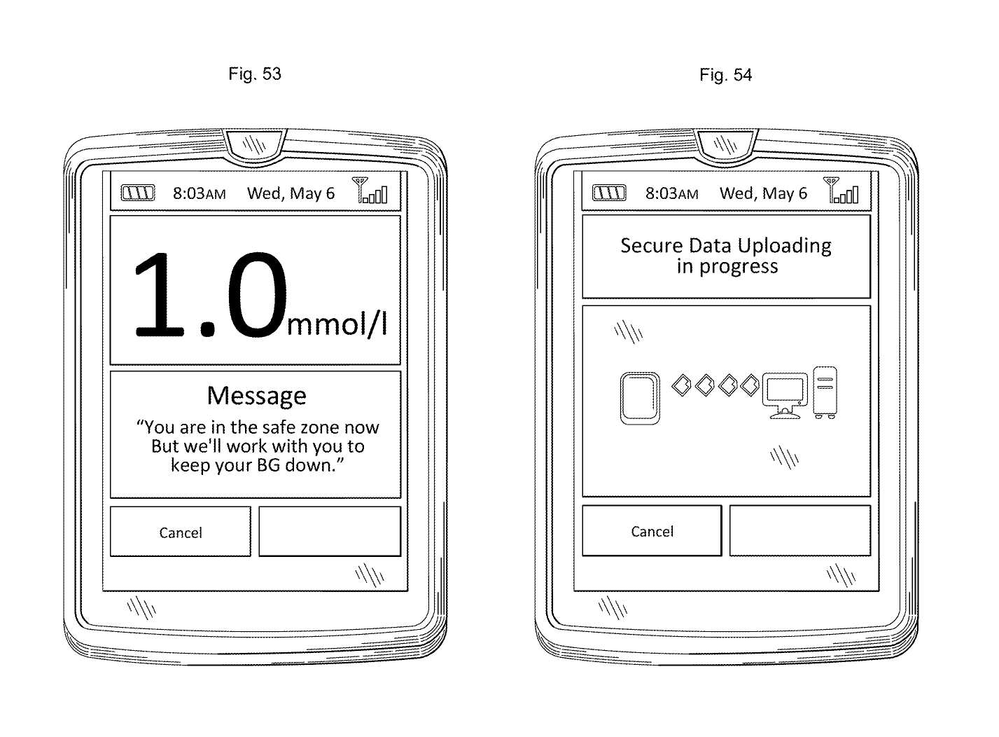

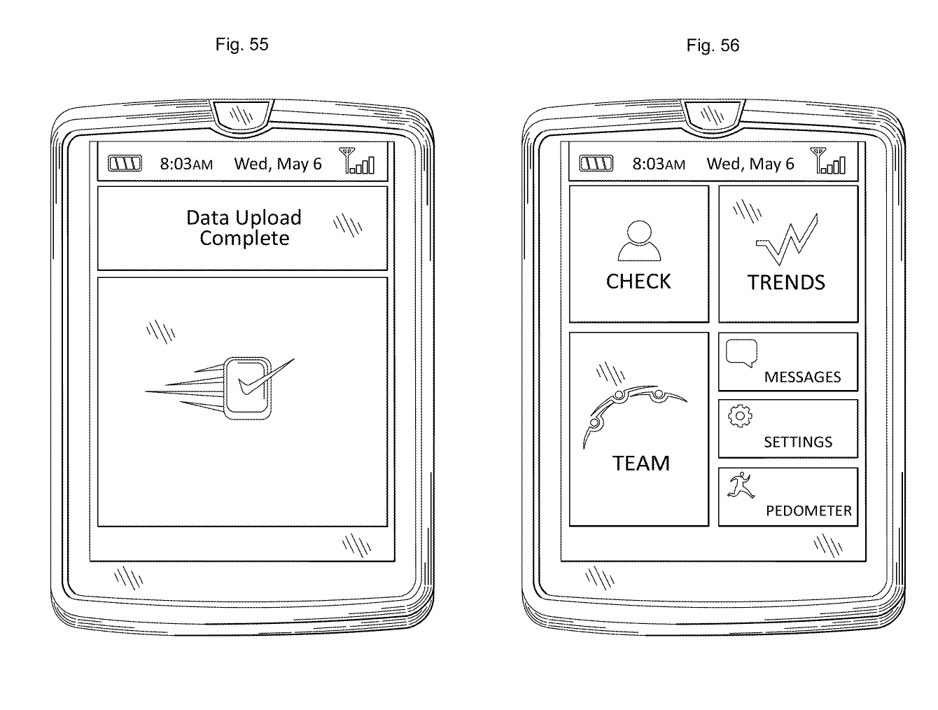

FIG. 46 is a display following BG testing, like FIG. 39, but in this case the BG test showed the user's BG to be 300 mg/dl, which is above a threshold (of about 250 mg/dl), and thereby indicates the user should do ketone testing. In FIGS. 47 and 48, the user associates the reading with after lunch, and adds the quantity of carbohydrate ingested at lunch. FIG. 49 is the display as in FIG. 42, for associating feelings and after exercise with the reading. FIG. 50 shows the screen indicating the user should commence ketone testing, but also showing the user's last BG reading and his steps and calories for that day. FIG. 51 shows the device is ready to check ketones, FIG. 52 shows the ketone check in progress, and FIG. 53 shows the results (1 mmol/l) and displays a message for the user indicating the ketone level determined is not an immediate health concern. FIG. 54 indicates the data from the device is uploading to the server, and FIG. 55 indicates the upload is complete.

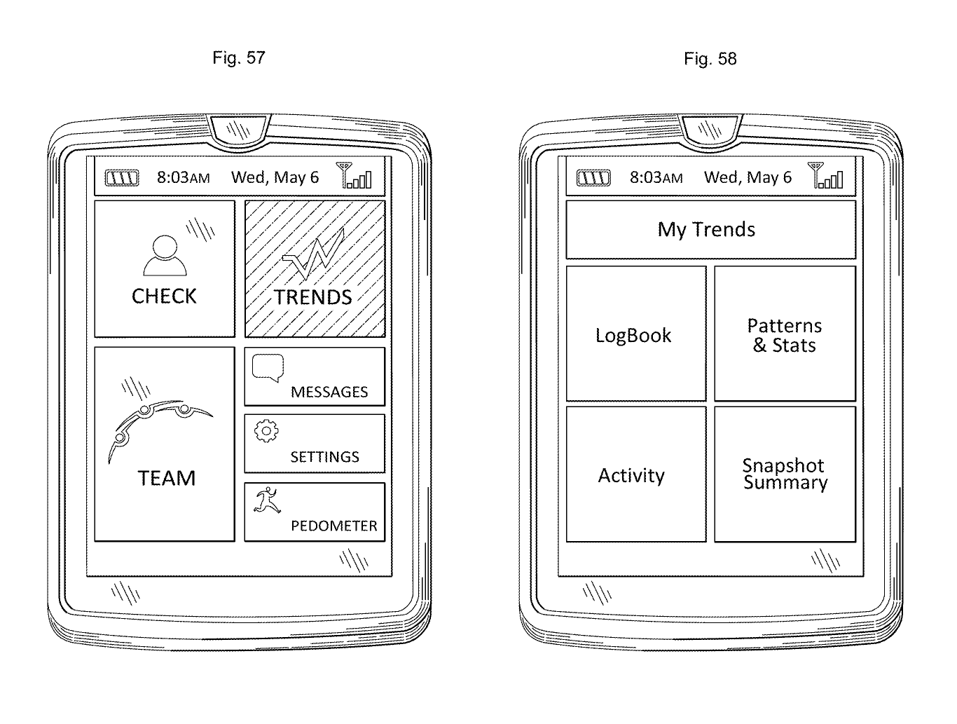

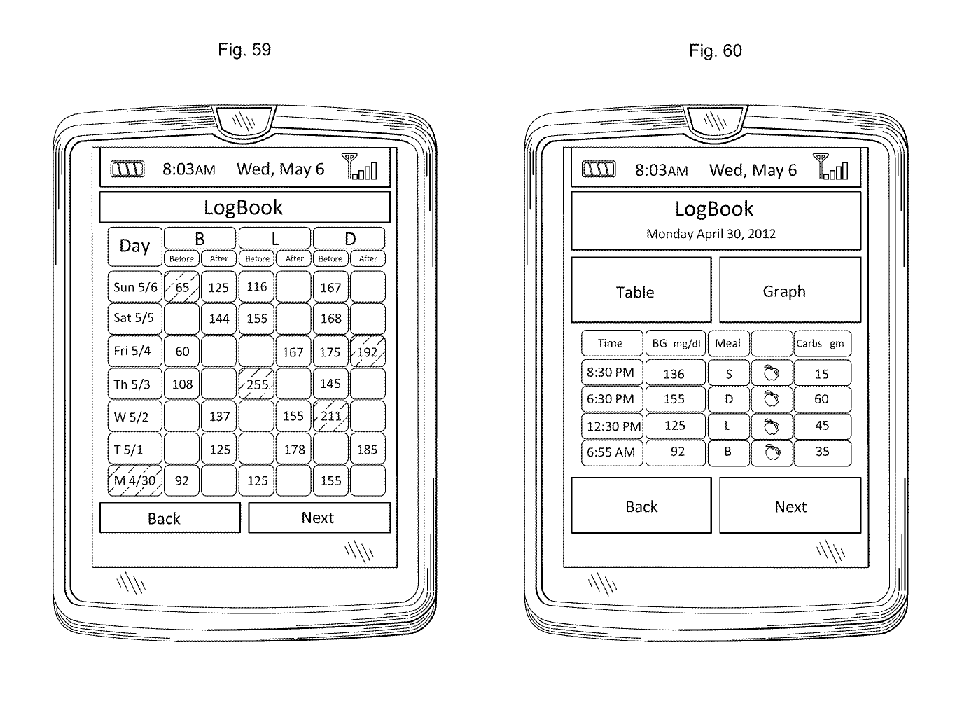

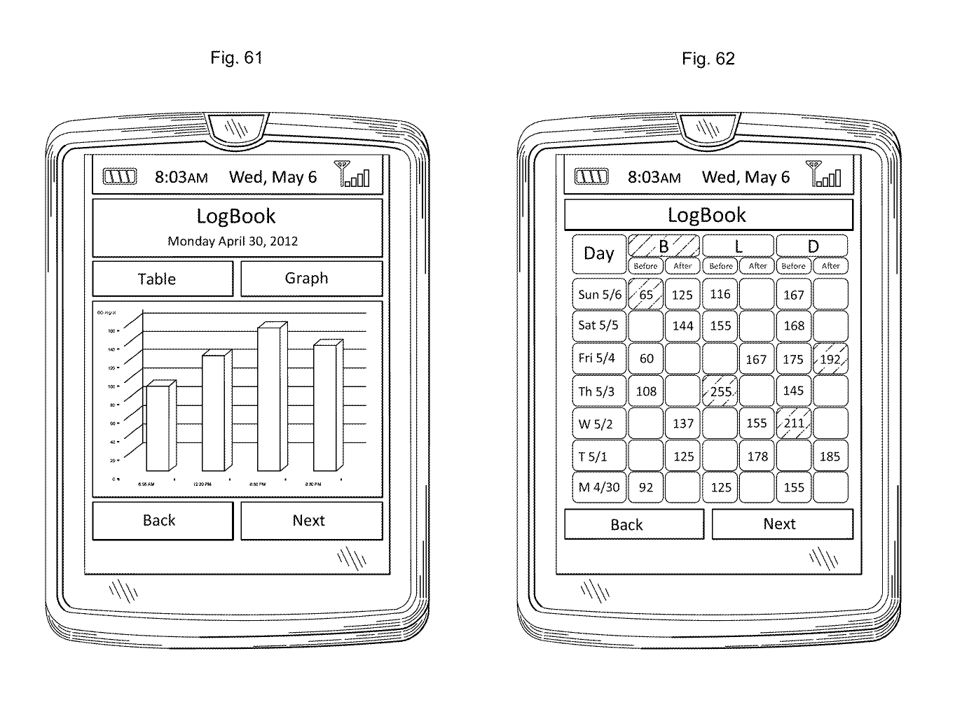

FIG. 57 depicts the home screen display with the Trends icon activated, and FIG. 58 shows the first Trends display. FIG. 59 shows the display when the Logbook icon in FIG. 58 is activated. FIG. 59 shows the BG readings before and after each meal over the prior week, with the user activating the screen to display the data only for April 30. FIG. 60 shows the BG readings for April 30, at each mail (including “S” for snack), the time of the reading and with the grams of carbohydrate ingested at each meal. FIG. 61 shows the BG readings for April 30 in graphical form (when the “Graph” icon in FIG. 60 is activated).

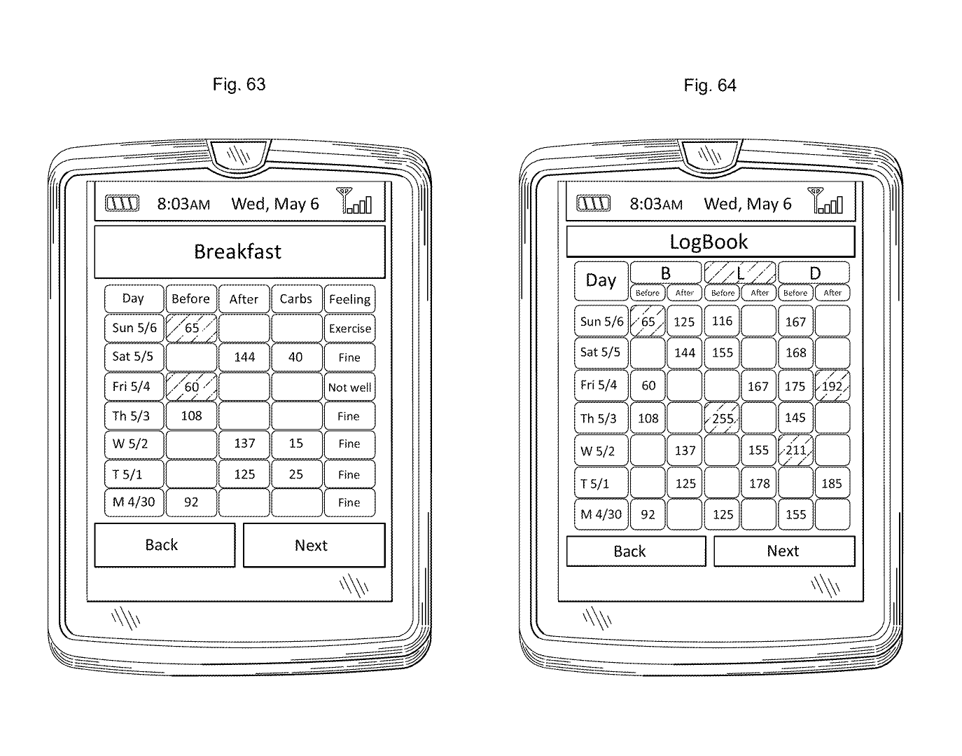

FIG. 62 shows that the user has returned to the display of FIG. 59, by activating the Table icon in FIG. 61. FIG. 63 shows the display when the Breakfast icon in FIG. 62 is activated. The BG readings before and after breakfast over the prior week are displayed, along with the grams of carbohydrate consumed at each breakfast and the user's feelings.

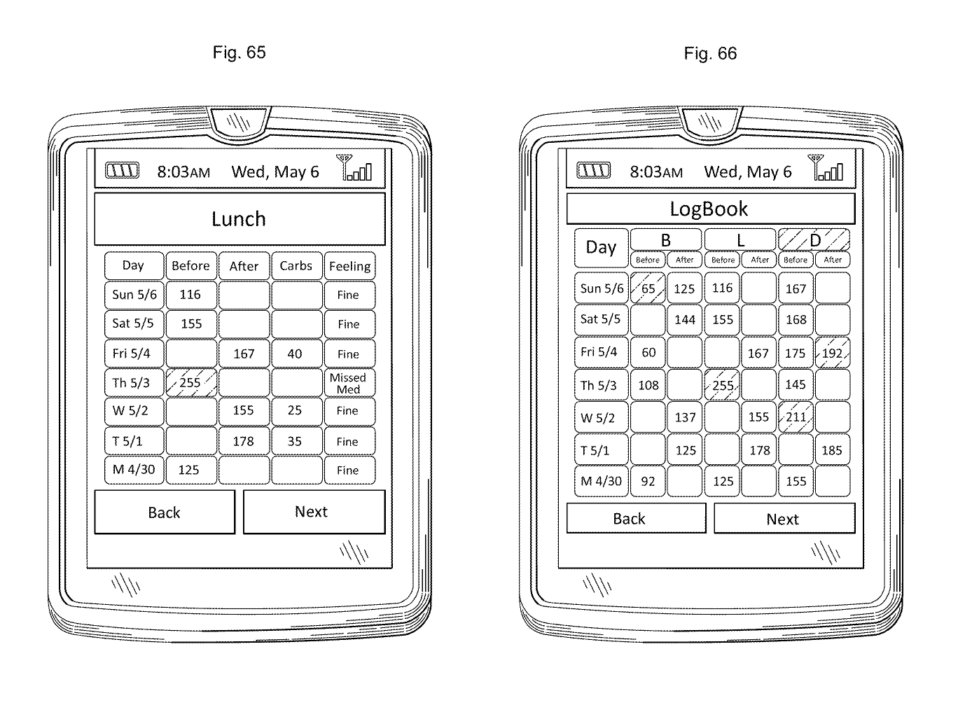

FIG. 64 shows that the user has returned to the display of FIG. 59, by activating the Back icon in FIG. 63. FIG. 65 shows the display when the Lunch icon in FIG. 64 is activated. The BG readings before and after lunch over the prior week are displayed, along with the grams of carbohydrate consumed at each lunch and the user's feelings.

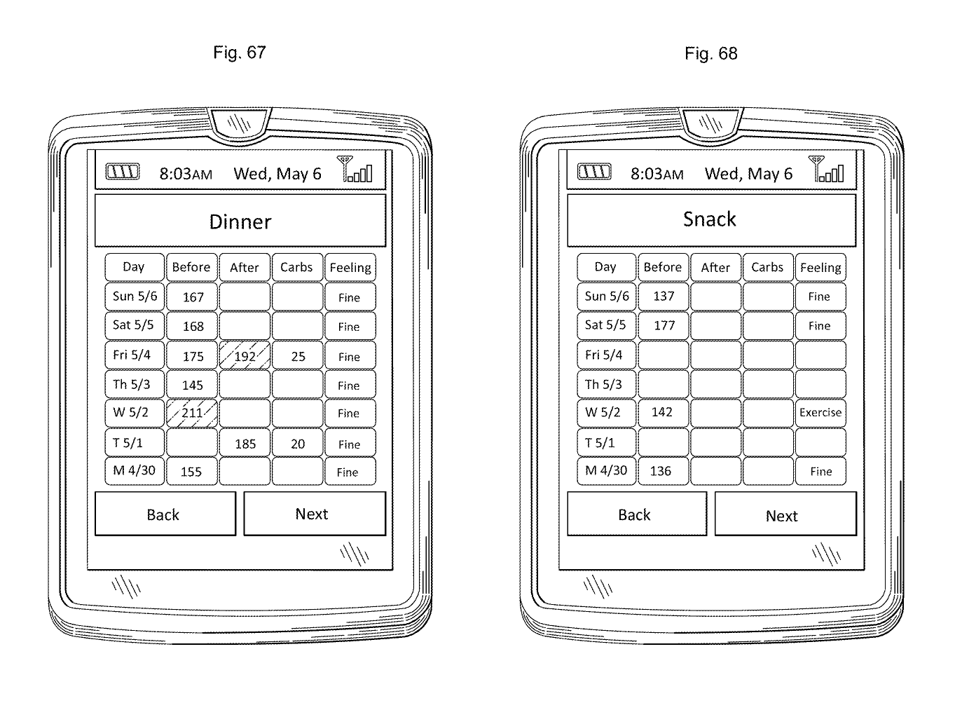

FIG. 66 shows that the user has returned to the display of FIG. 59, by activating the Back icon in FIG. 65. FIG. 67 shows the display when the Dinner icon in FIG. 66 is activated. The BG readings before and after dinner over the prior week are displayed, along with the grams of carbohydrate consumed at each dinner and the user's feelings. FIG. 68 shows the BG readings before and after a snack over the prior week, along with the grams of carbohydrate consumed at each snack and the user's feelings.

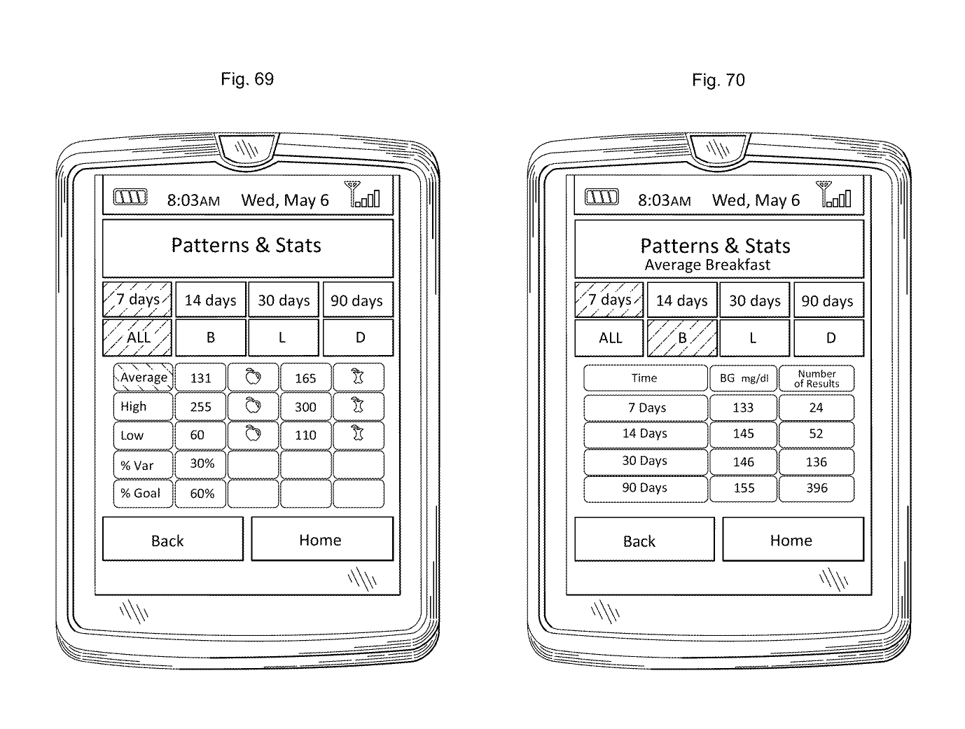

FIG. 69 shows the display when the Patterns and Stats icon of FIG. 58 is activated. FIG. 70 shows the display when the 90 Days icon is activated on FIG. 69, along with the B (breakfast) icon. In FIG. 70, the BG results average at 7, 14, 30 and 90 days are shown, along with the number of results the average BG is determined from.

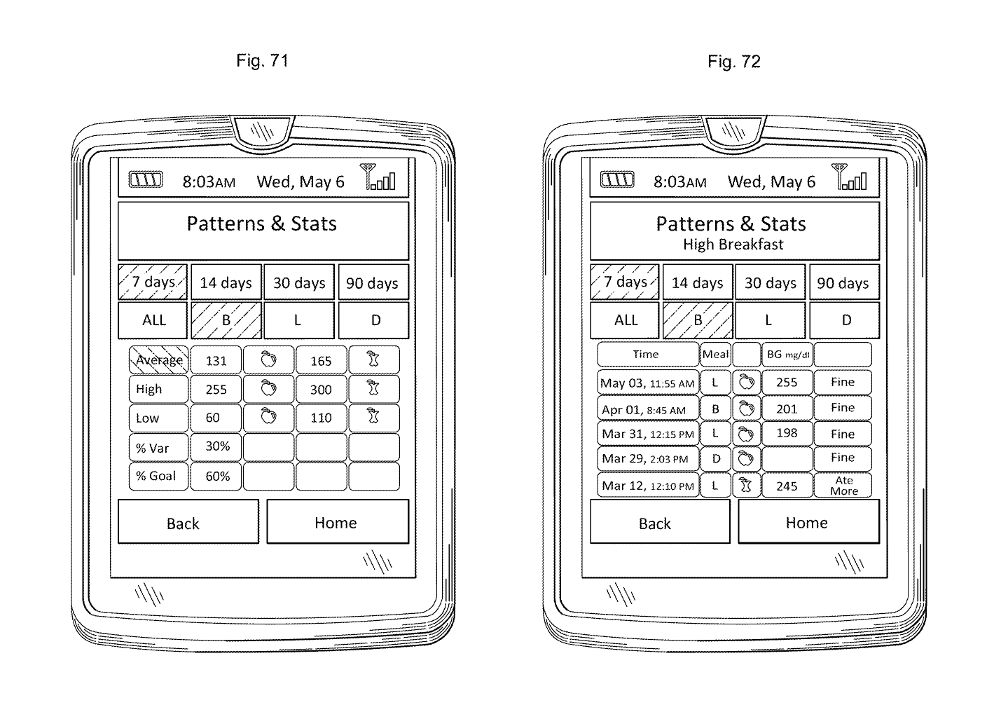

FIG. 72 shows the display of FIG. 71 (same as FIG. 69), with the “7 Days,” “High,” and “All” icons activated. The high BG readings over the prior 7 days, after the meal indicated and also showing the user's feelings, are shown.

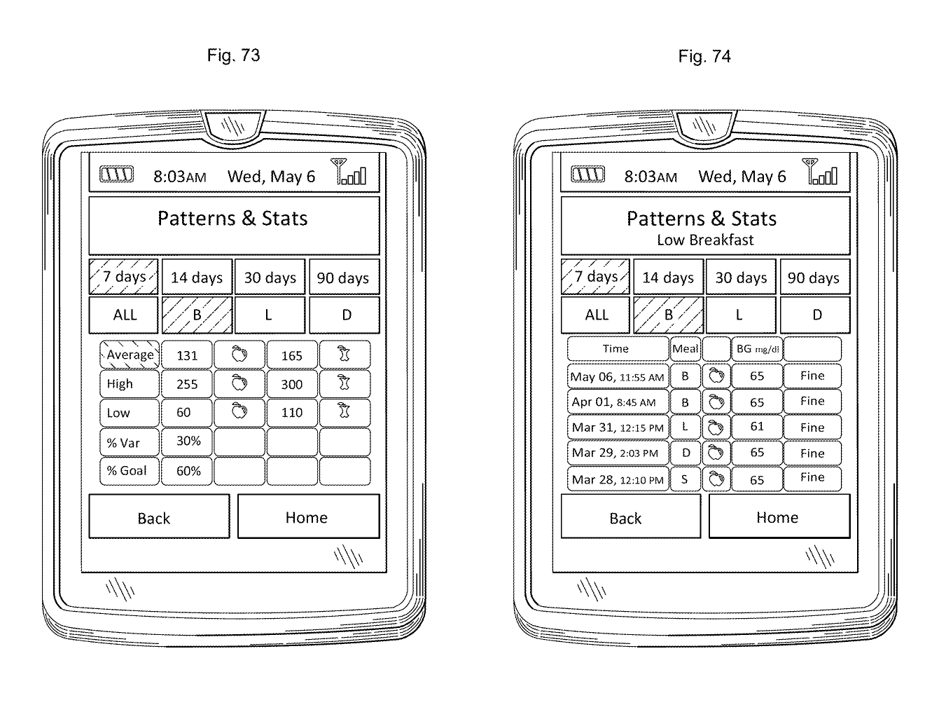

FIG. 73 shows the display of FIG. 71, with the “7 Days,” “Low,” and “All” icons activated. In FIG. 74, the low BG readings over the prior 7 days, after the meal indicated and also showing the user's feelings, are shown.

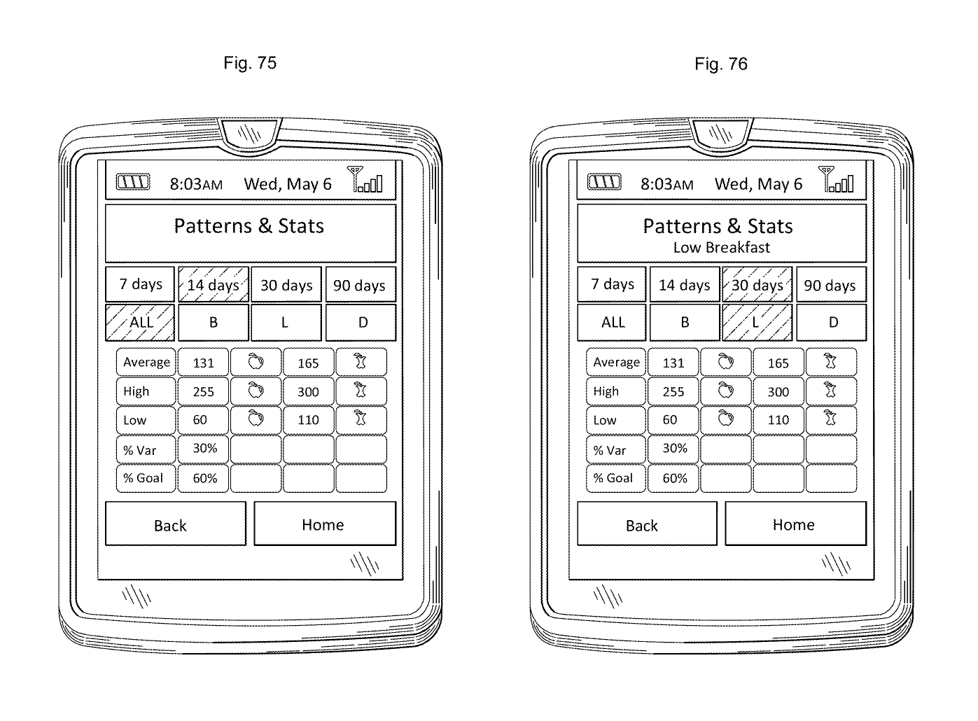

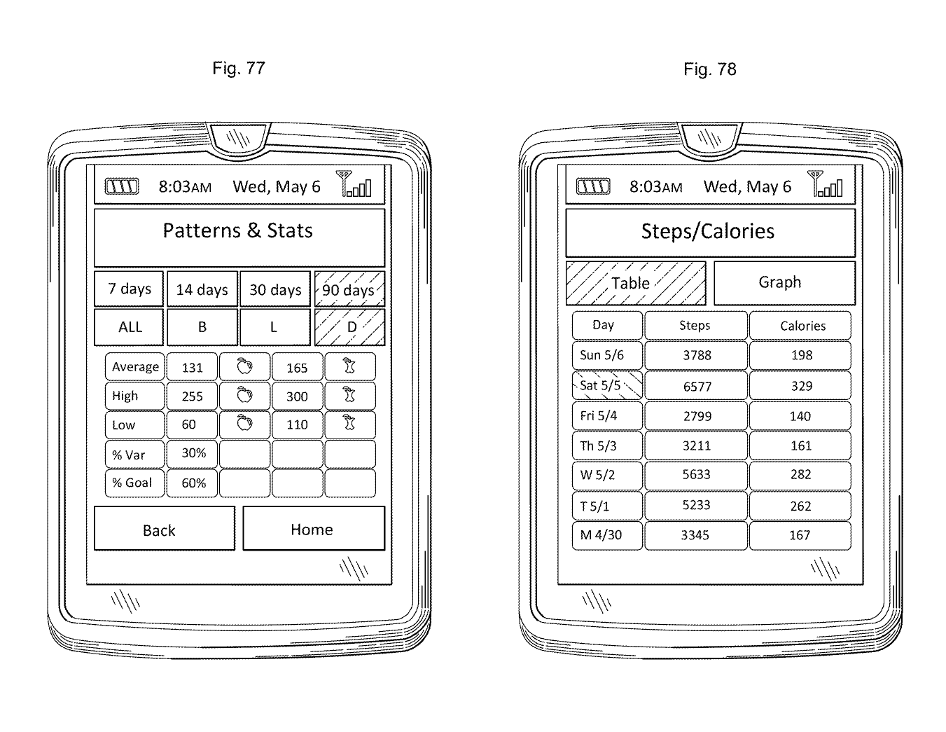

In FIG. 75, the “30 Days” and “Lunch” icons are activated, and in FIG. 76 the display is of the BG average, high, low, percent variance and percent of goal, before and after lunch, over 30 days. In FIG. 77, the user is activating icons to view the average BG values over the past 90 days dinners.

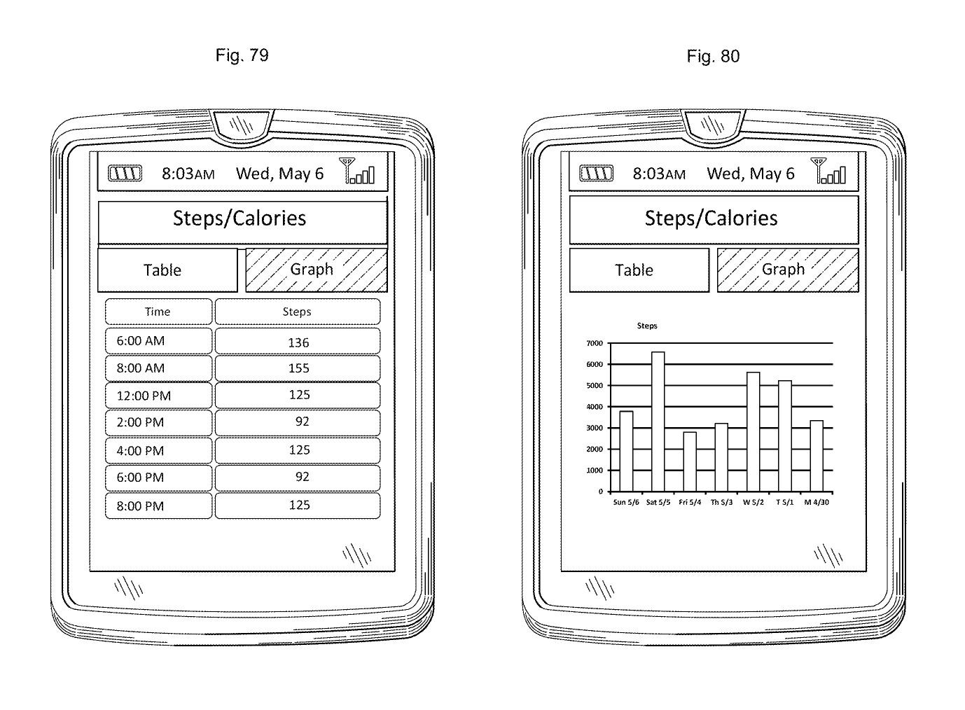

FIG. 78 shows the screen when the Activity icon of FIG. 58 is activated. The display shows the user's daily steps and calories expended over the prior week. In FIG. 78, the Table icon and the “Saturday 5/5” icons are activated, and FIG. 79 shows the tabular display of the user's steps, at several different times of day, for May 5. FIG. 80 shows the display when the Graph icon in FIG. 79 is activated—it is the user's steps of FIG. 78 (over the prior week) in graphical depiction.

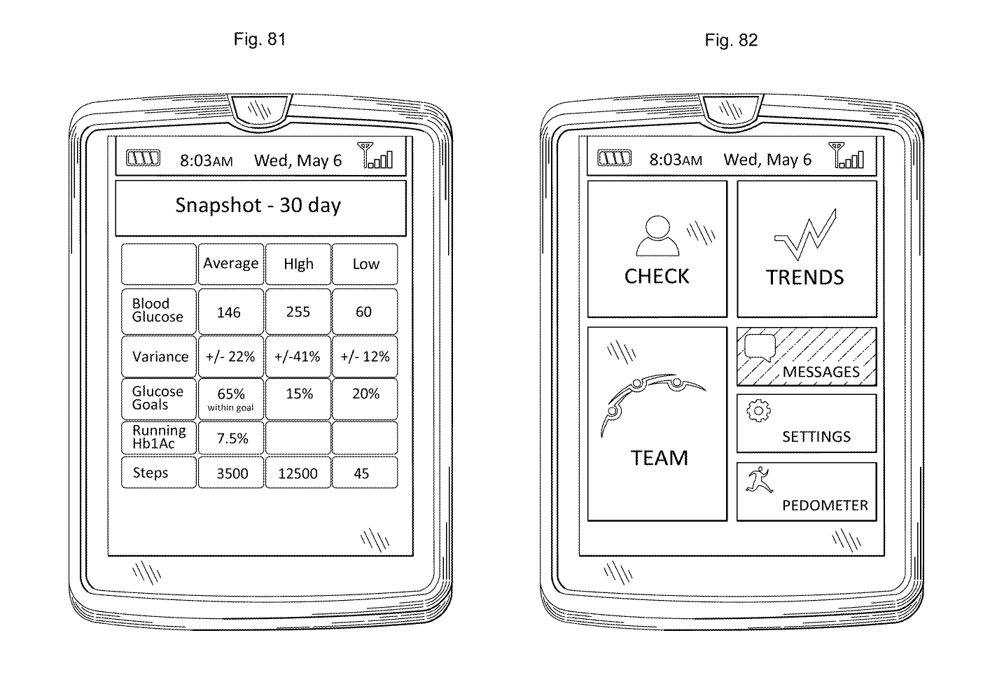

FIG. 81 shows the display when the Snapshot Summary icon of FIG. 58 is activated. The new information displayed is the running Hb1Ac, shown as a percentage, along with the other displayed information, over the prior 30 days.

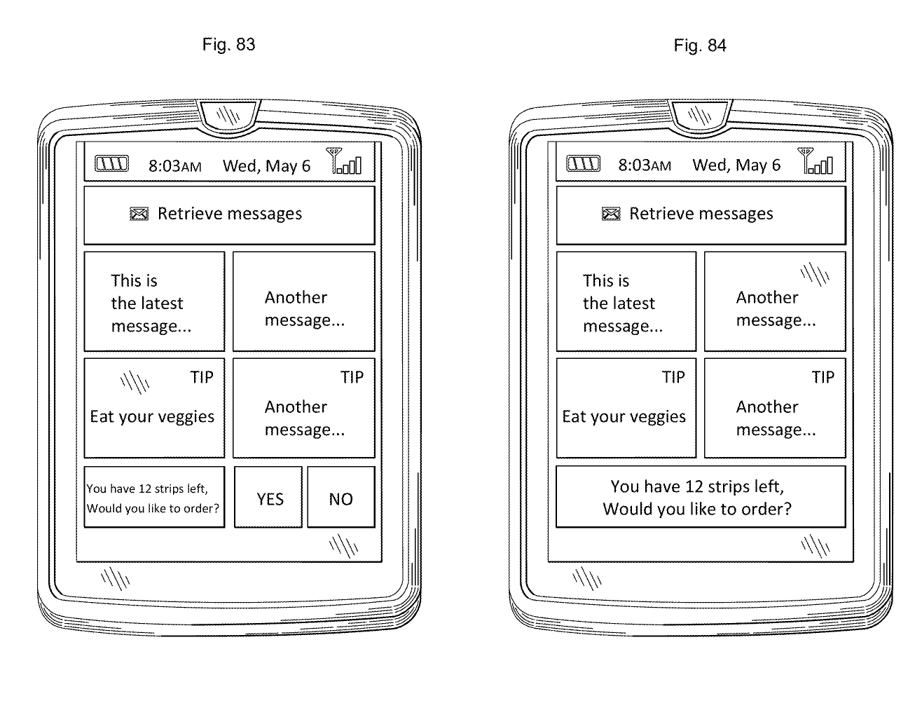

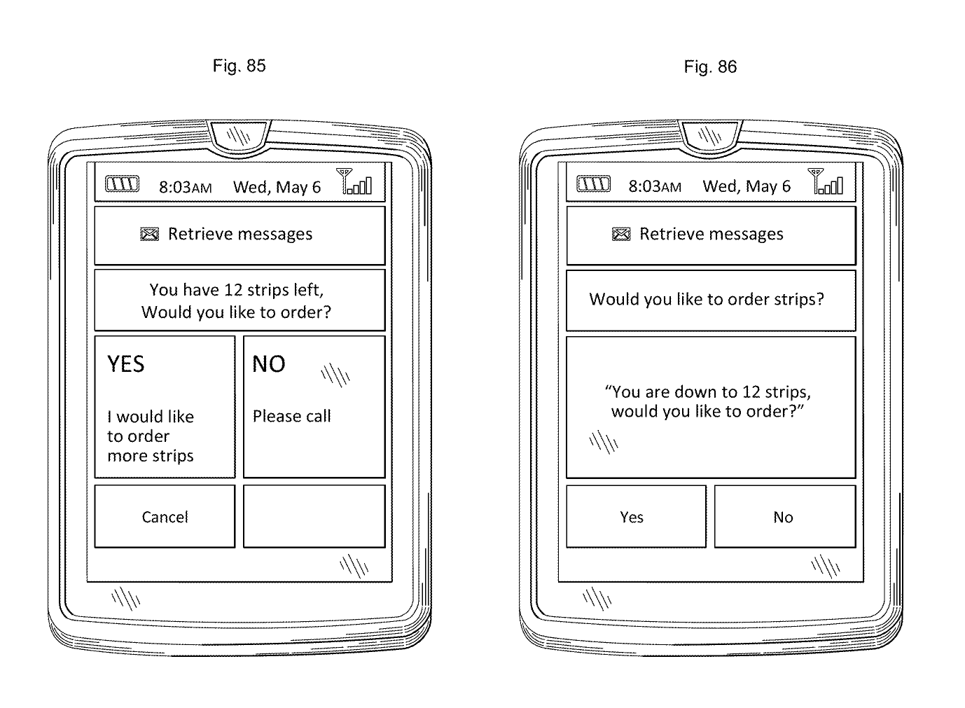

FIG. 82 shows the screen of FIG. 58 with the messages icon activated, and FIG. 83 shows the messages display, where several messages can be selected for display, and a message showing the number of test strips remaining—and whether the user would like to order more—is also shown. FIGS. 84 to 86 show different variations on the message relating to number of strips left and ordering more.

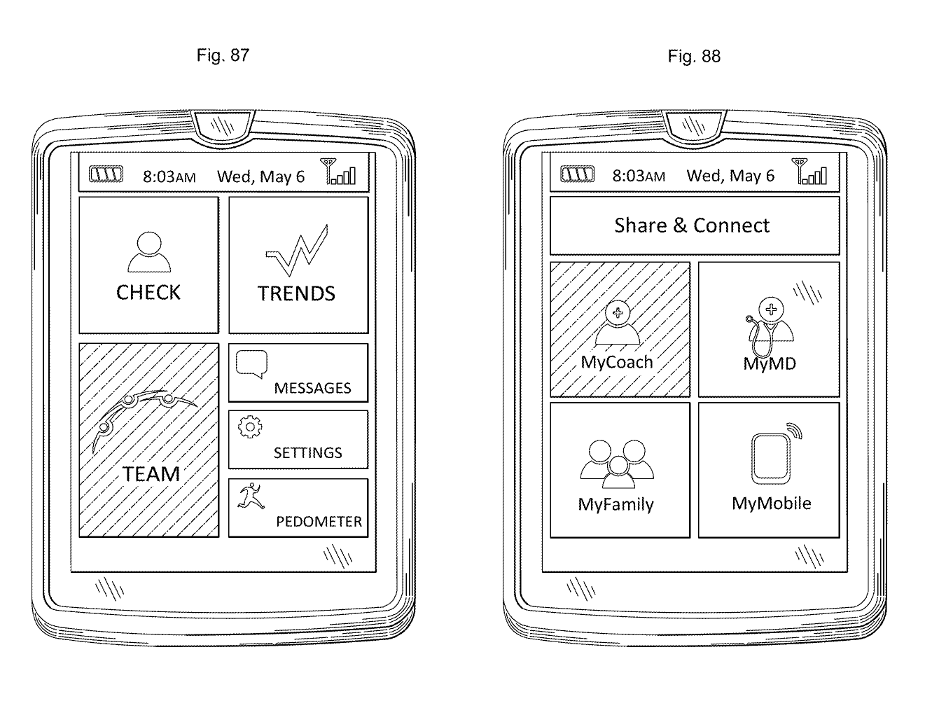

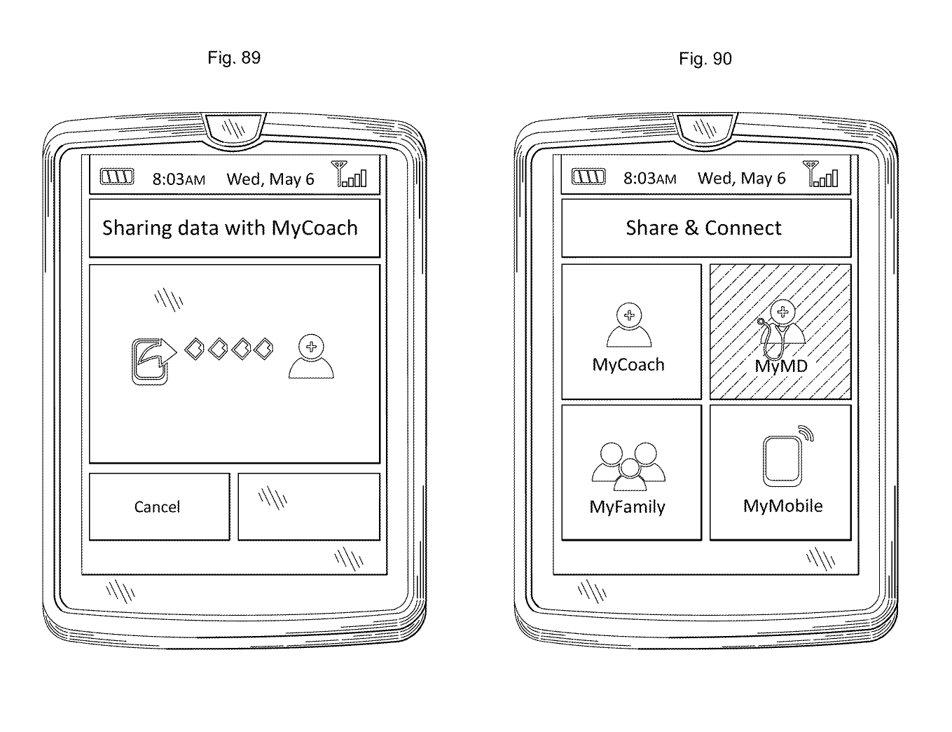

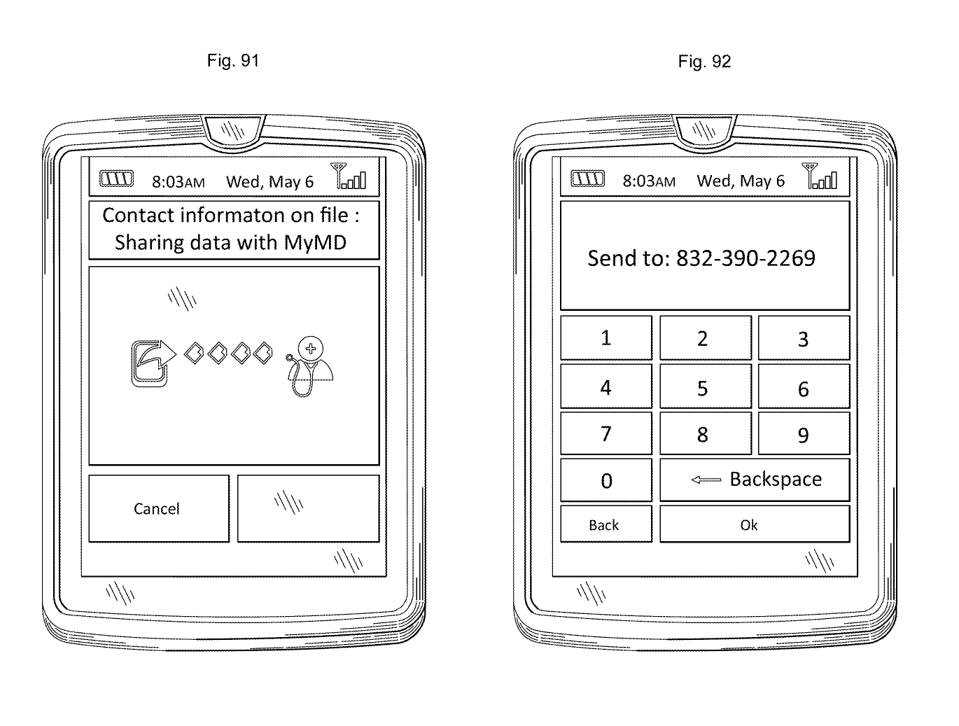

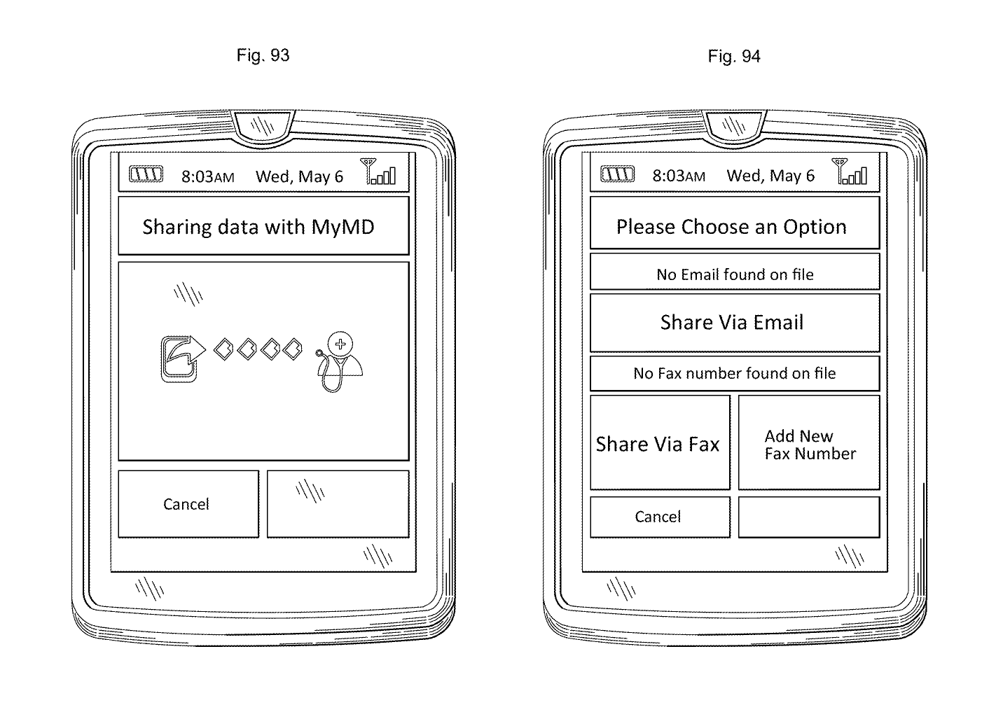

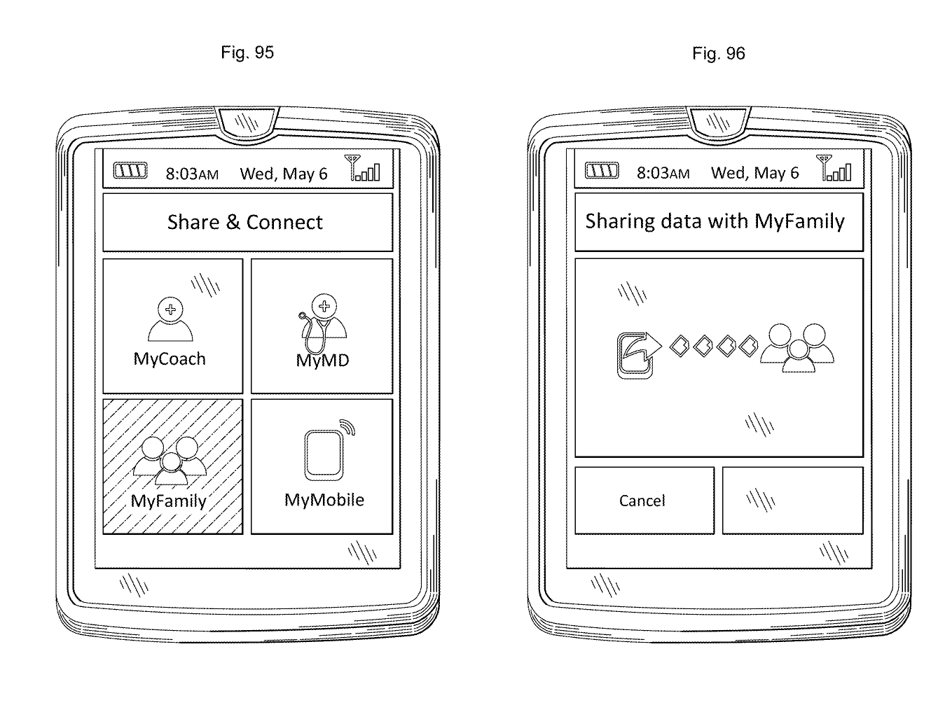

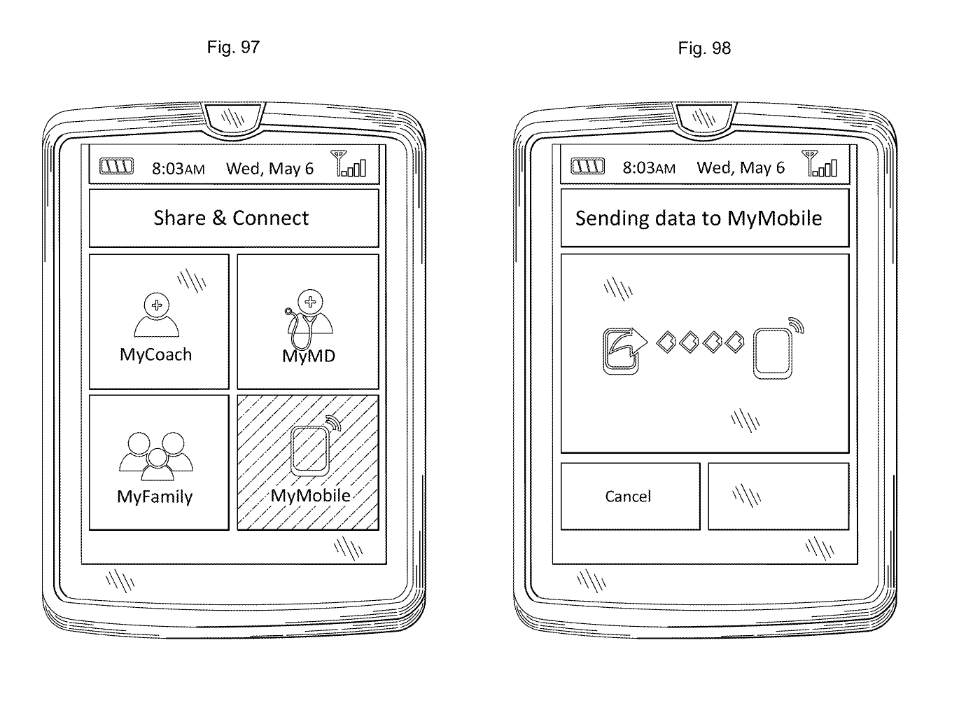

FIG. 87 shows the screen of FIG. 58 with the Team icon activated, and FIG. 88 shows icon representing each member of the team, and with the “MyCoach” icon activated. FIG. 89 shows the device sending data to the site designated as “MyCoach” for analysis. FIG. 90 shows the same screen as FIG. 88 with the “MyMD” icon activated. FIG. 91 shows the device sending data to the site designated as “MyMD” for analysis. FIG. 92 indicates the data was sent to MyMD as a text or SMS message. FIG. 93 indicates the data is being shared with MyMD. FIG. 94 indicates the data can be shared by fax or email. FIG. 95 shows the same screen as FIG. 88 with the “MyFamily” icon activated. FIG. 96 shows the device sending data to the site designated as “MyFamily.” FIG. 97 shows the same screen as FIG. 88 with the “MyMobile” icon activated. FIG. 98 shows the device sending data to the site designated as “MyMobile.”

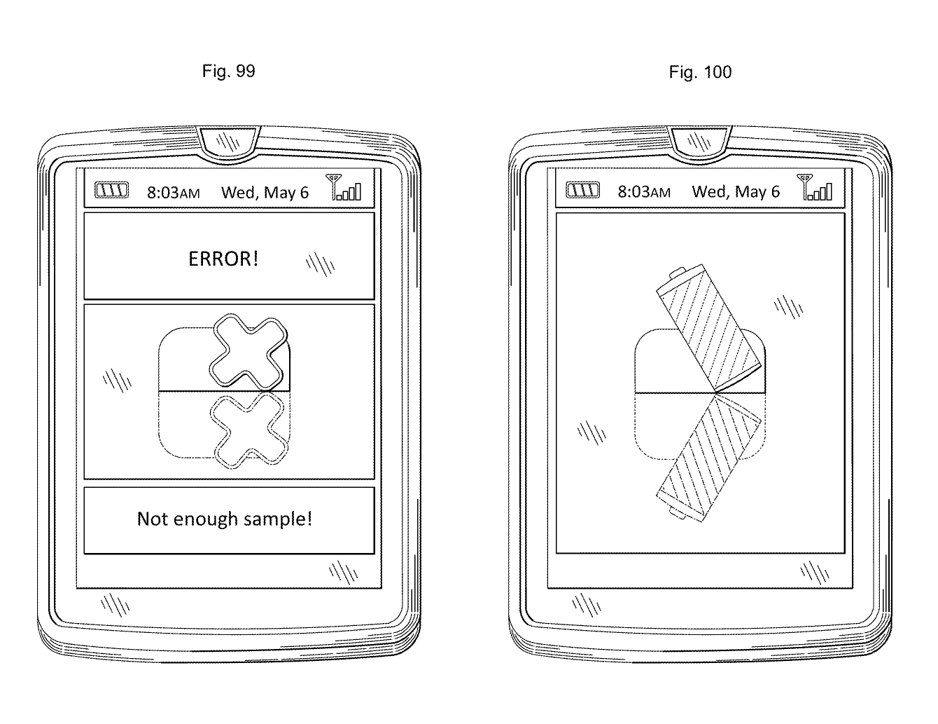

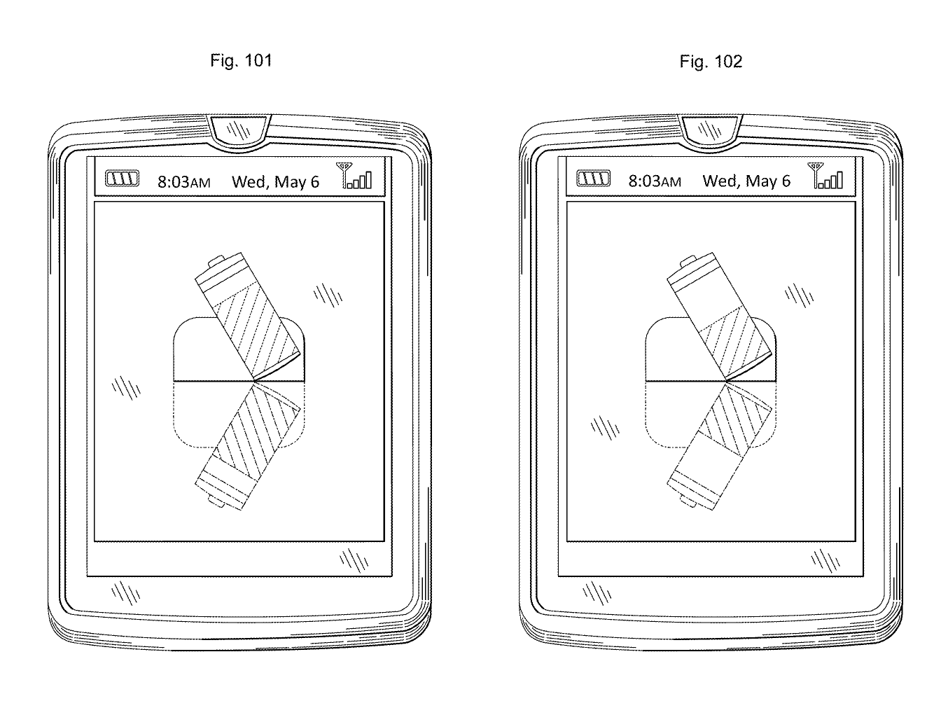

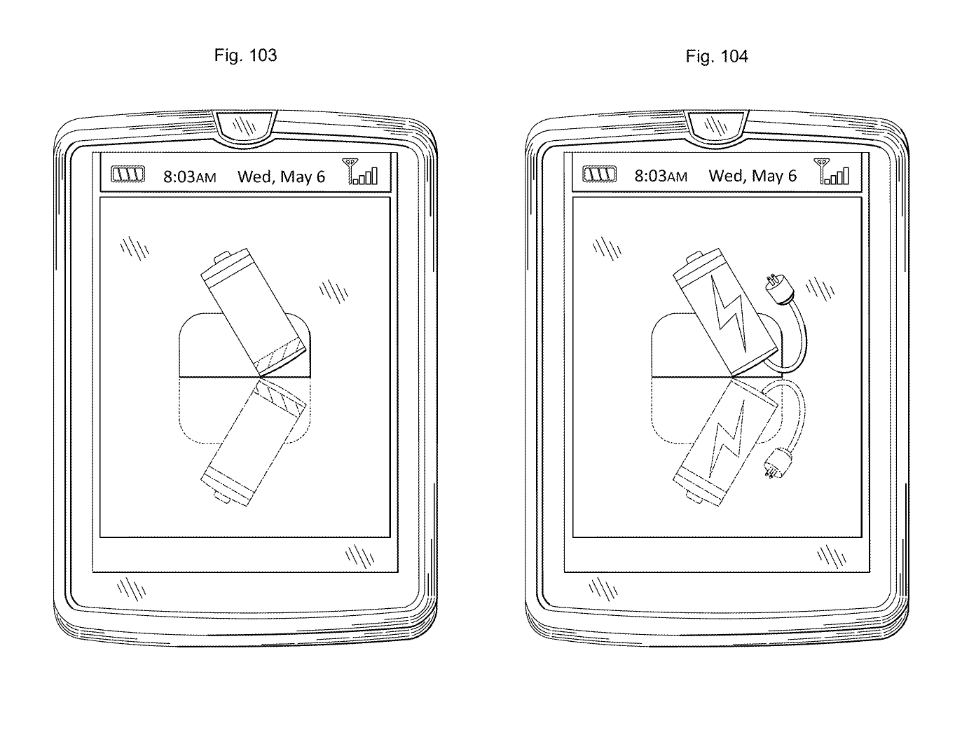

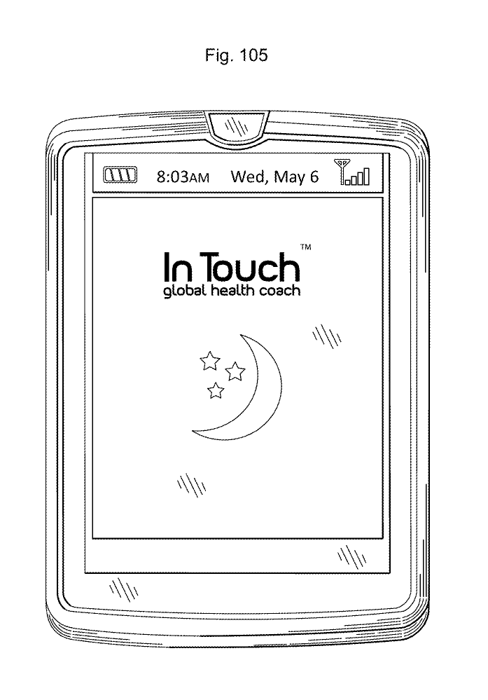

FIG. 99 depicts the display when the blood glucose strip has been inserted with an insufficient blood sample for testing. FIGS. 100 to 105 are adequately explained in the Drawing description section above.

The device and system used herein can exchange the data and information as described above, but can also monitor and display choices for food, exertion, testing, insulin or drug administration, or any other choice or user preference as described in any of the predecessor applications priority is claimed to.

The specific methods, processes and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The invention has been described broadly and generically herein. Each of the narrower species and subgeneric groupings falling within the generic disclosure also form part of the invention.

The teems and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

I claim:

1. A business method to improve diabetes healthcare with interactive monitoring of blood glucose levels, comprising:
issuing diabetic users a hand-held device with a series of user-interactive screens with several icons per screen, wherein the user can trigger one or more icons to accomplish all of the following:
set alarm times and sounds to indicate that blood glucose should be tested and/or ketone levels should be tested, food should be consumed, or exercise should begin;
set into airplane mode to not interfere with airline flight equipment during air travel;
confirm functioning of the glucose and ketone test strips and test solutions against a control;
set the pedometer/accelerometer to varying stride lengths, and to displaying steps per designated unit of time, calories consumed per designated unit of time, total distance traveled per unit of time and average speed;
retrieve from the server and display messages relating to diabetes wellness education and suggested actions;
permit entry of the meal associated with a BG reading, whether the BG level was before or after a particular meal, the quantity of carbohydrate ingested at the meal, and the user's feelings near the meal;
display BG values, including BG highs and lows, or average BG, over: designated time periods, before and after meals, and display the quantity of carbohydrate consumed at the meals and the user's feelings near the meal;
display BG variation over time as a percentage from the mean, and BG values as a percentage of a BG target, and also HB1Ac values and averages;
read glucose or ketone test strips and display BG values, with a display of how to insert a test strip into the device and a display indicating whether the test strip is correctly inserted;
communicate results of BG and ketone testing, and user's steps, calories and distance traveled to a server, which can provide advice and educational messages based on said results;
communicate said results to physicians and health monitors, who can alert user or emergency services to problems;
communicate said results to family members, and/or to personal devices of the user or others;
and wherein the server also automatically communicates the following to the user:
instruct ketone testing by the user if the BG tests above 250 mg/dl;
instruct the user to eat preferred foods if the user's BG tests below a specified level; and
count the number of test strips consumed, and indicates when a significant number of strips have been consumed and more should be ordered; and
wherein the users are charged for using the interactive system such that the cost of the complete interactive service and including blood glucose and ketone test strips, is less than cost for the competitor's blood glucose test strips alone during the same period.

2. The method of claim 1 wherein the preferred foods are vegetables and foods with low glycemic index.

3. The method of claim 1 further including progressive personalization of food choices including by food characteristics of texture, color, softness, tartness, sweetness, degree of spicy, meaty, fruity, mushy, oily or firm.

4. The method of claim 1 further including indicating the number of strips remaining and allowing for ordering from the device by the user.

5. The method of claim 1 further including providing educational messages and summaries of BG levels to the user.

6. The method of claim 1 further including an icon to display the device battery charge level.

7. A hand-held device with a series of user-interactive screens with several icons per screen, wherein the user can trigger one or more icons to accomplish all of the following:
set alarm times and sounds to indicate that blood glucose should be tested and/or ketone levels should be tested, food should be consumed, or exercise should begin;
set into airplane mode to not interfere with airline flight equipment during air travel;
confirm functioning of the glucose and ketone test strips and test solutions against a control;
confirm that the glucose and ketone test strips are properly positioned;
indicate the user BG level and if greater than a threshold, automatically instruct ketone test strip insertion and ketone testing;
permit entry of the meal associated with the user BG level, whether the BG level was before or after a particular meal, the quantity of carbohydrate ingested at the meal, and the user's feelings near the meal;
permit the user to display BG levels as averages, highs or lows over time, as well as to display Hb1Ac values, the average percent the BG level is from a target level, and the percent variance of the BG level from the mean;
display the quantity of carbohydrate consumed at the meals and the user's feelings near the meal, over time;
set the pedometer/accelerometer to varying stride lengths, and to displaying steps per designated unit of time, calories consumed per designated unit of time, total distance traveled per unit of time and average speed;
retrieve from the server and display messages relating to diabetes wellness education and suggested actions;
communicate results of BG and ketone testing, and user's steps, calories and distance traveled to a server, which can provide advice and educational messages based on said results and log results over time;
communicate said results to physicians and health monitors, who can alert user or emergency services to problems;
communicate said results to family members, and/or to personal devices of the user or others;
and wherein the server also automatically communicates the following to the user:
instruct the user to eat preferred foods if the user's BG tests below a specified level; and
count the number of test strips consumed, and indicates when a significant number of strips have been consumed and more should be ordered.

8. The device of claim 7 wherein the preferred foods are vegetables and foods with low glycemic index.

9. The device of claim 7 further including progressive personalization of food choices including by food characteristics of texture, color, softness, tartness, sweetness, degree of spicy, meaty, fruity, mushy, oily or firm.

10. The device of claim 7 further including indicating the number of strips remaining and allowing for ordering from the device by the user.

11. The device of claim 7 further including an icon to display the device battery charge level.

12. The device of claim 7 wherein the threshold BG level is 250 mg/dl.
